(19) United States
(12) Patent Application Publication
(10) Pub. No.: US 2026/0204116 A1
(43) Pub. Date: Jul. 16, 2026

(54) IMAGE DATA ENABLED ACCESS CONTROL SYSTEMS AND METHODS

(71) Applicant: THE CHAMBERLAIN GROUP LLC, OAK BROOK, IL (US)

(72) Inventors: Nathan Kopp, Edmonds, WA (US); Benjamin Hunt, Oak Park, IL (US); Jishnu Kinwar, Lisle, IL (US)

(21) Appl. No.: 19/449,823

(22) Filed: Jan. 15, 2026

Related U.S. Application Data
(60) Provisional application No. 63/745,561, filed on Jan. 15, 2025.

(51) Int. Cl. G07C 9/00; G06V 20/52; G07C 9/10; G08B 13/196

(52) U.S. Cl. CPC G07C 9/00563; G06V 20/52; G07C 9/10; G08B 13/19613

(57) ABSTRACT

Systems and methods of initiating an auto-secure operation associated with a movable barrier operator including: capturing data associated with a region of interest; detecting an object entering the region of interest; analyzing the data to determine whether the object is a trusted entity; in response to determining the object is a trusted entity, determining a re-identification characteristic associated with the trusted entity; storing the re-identification characteristic; detecting a new object entering the region of interest after the trusted entity exited the region of interest; analyzing the data to determine presence of the re-identification characteristic for the new object; and initiating an auto-secure operation including sending a close command to a movable barrier operator to cause the movable barrier operator to close a movable barrier in response to determining a lack of presence of the re-identification characteristic for the new object.

### CROSS-REFERENCE TO RELATED APPLICATIONS

The present application claims priority to U.S. Provisional Patent Application Serial No. 63/745,561 filed on January 15, 2025, the disclosure of which is incorporated by reference herein in its entirety.

### TECHNICAL FIELD

This disclosure relates to access control systems and, more specifically, to access control systems that utilize image data as an input to the access control system.

### BACKGROUND

Access control systems are known, including smart lockset systems and movable barrier operators, to control access to a secured area such as a residence. Some access control systems utilize a camera to capture images or video of one or more monitored areas outside of the secured area, such as lawn, driveway, and/or alley by the residence. The access control system may initiate an alarm and/or communicate an alert or a notification to a portable electronic device, such as a smartphone, of a user associated with the residence upon the access control system detecting a security event such as person entering the monitored area.

### Brief Description

Aspects and advantages of the invention in accordance with the present disclosure will be set forth in part in the following description, or may be obvious from the description, or may be learned through practice of the technology.

In accordance with one embodiment, a method of initiating an auto-secure operation associated with a movable barrier is provided. The method includes capturing, via a camera system, image data associated with a region of interest associated with the camera system; detecting, via the camera system, an object entering the region of interest; analyzing, via a processor in communication with the camera system, the image data to determine whether the object is a trusted entity; in response to determining the object is a trusted entity, analyzing the image data to determine a re-identification characteristic associated with the trusted entity; storing the re-identification characteristic in a ledger; detecting, via the camera system, a new object entering the region of interest after the trusted entity exited the region of interest; analyzing, via the processor, the image data to determine presence of the re-identification characteristic for the new object; and initiating an auto-secure operation including sending a close command to a movable barrier operator to cause the movable barrier operator to close a movable barrier associated with the movable barrier operator in response to determining a lack of presence of the re-identification characteristic for the new object.

In accordance with another embodiment, a non-transitory computer-readable medium storing instructions which, when executed by a processor, cause performance of a method of initiating an auto-secure operation of a movable barrier operator is provided. The method includes receiving, at an access control system, a person detection signal indicative of a person within a region of interest near a movable barrier operator, wherein the person detection signal is determined in view of image data captured by a camera system; analyzing, by the access control system, the image data to determine a characteristic of the person, a biometric attribute of the person, indicia associated with the person, or a combination thereof; comparing, by the access control system, the characteristic to a re-identification characteristic associated with a known, entrusted entity; initiating, by the access control system, an auto-secure operation based on the comparing, wherein initiating the auto-secure operation comprises: formulating, by the access control system, an unknown person detected notification; transmitting the unknown person detected notification to a user device; and sending a close command to the movable barrier operator to cause the movable barrier operator to close a movable barrier associated with the movable barrier operator.

In accordance with another embodiment, a camera subsystem for use with a movable barrier operator is provided. The camera subsystem includes a camera system that receives a camera system input selected from a group including an environment input, a power input, an ambient lighting input, a visual input, an audio input, and a motion input; and a server subsystem, wherein the server subsystem comprises a processor coupled to a memory, the processor configured to: process image data received from the camera system to determine whether a person is present in the image data; analyze the image data to determine whether the person is a trusted entity; in response to determining the person is a trusted entity, analyze the image data to determine a re-identification characteristic associated with the trusted entity; cause the re-identification characteristic to be stored in a ledger; detect a new person present in the image data; analyze the image data to determine presence of the re-identification characteristic for the new person; and initiate an auto-secure operation including sending a close command to a movable barrier operator to cause the movable barrier operator to close a movable barrier associated with the movable barrier operator in response to determining a lack of presence of the re-identification characteristic for the new person.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

FIG. 1 is a view of an example movable barrier operator system for operating a garage door in accordance with example embodiments;

FIG. 2 is an example block diagram of an access control system for use in connection with the movable barrier operator system of FIG. 1 in accordance with example embodiments;

FIG. 3 is a view of another example block diagram of the access control system of FIG. 2;

FIG. 4 is a flow diagram showing an example operating method of the access control system of FIGS. 2 and 3 in accordance with example embodiments;

FIG. 5 is a flow diagram showing an example operating method of the access control system of FIGS. 2 and 3 in accordance with example embodiments;

FIG. 6 is a flow diagram showing an example operating method of the access control system of FIGS. 2 and 3 in accordance with example embodiments;

FIG. 7 is a flow diagram showing an example operating method of the access control system of FIGS. 2 and 3 in accordance with example embodiments;

FIG. 8 is a flow diagram showing an example operating method of the access control system of FIGS. 2 and 3 in accordance with example embodiments;

FIG. 9 is an example graphical user interfaces of a user device for controlling various aspects of the access control system of FIGS. 2 and 3 in accordance with example embodiments;

FIG. 10 is an example graphical user interfaces of a user device for controlling various aspects of the access control system of FIGS. 2 and 3 in accordance with example embodiments;

FIG. 11 is an example graphical user interfaces of a user device for controlling various aspects of the access control system of FIGS. 2 and 3 in accordance with example embodiments;

FIG. 12 is an example graphical user interfaces of a user device for controlling various aspects of the access control system of FIGS. 2 and 3 in accordance with example embodiments;

FIG. 13 is an example graphical user interface for setting up one or more regions of interest for the access control system of FIGS. 2 and 3 in accordance with example embodiments;

FIG. 14 is an example graphical user interface for setting up one or more regions of interest for the access control system of FIGS. 2 and 3 in accordance with example embodiments;

FIG. 15 is an example graphical user interface for setting up one or more regions of interest for the access control system of FIGS. 2 and 3 in accordance with example embodiments;

FIG. 16 is an example graphical user interface for setting up one or more regions of interest for the access control system of FIGS. 2 and 3 in accordance with example embodiments; and

FIG. 17 is an example flow chart of a method of initiating an auto-secure operation in accordance with example embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions, operations and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein that utilize data from a sensor of an access control system to control operations of the access control system and control access to a secured area such as a residence. The sensor may include, for example, one or more cameras configured to capture image data from a monitored area associated with the residence. The access control system may include, for example, one or more locksets of doors of the residence and/or one or more movable barrier operators of the residence. The systems, apparatuses and methods as described herein are utilized in conjunction with an auto-secure operation that enables the access control system to secure the secured area against unwanted entry using smart controls.

Generally, secured areas such as residences may be approached by three types of entities, including known, entrusted entities (such as a known homeowner, a known registered guest, a known delivery person, a known employee or contractor, etc.), known, distrusted entities (such as known bad actors or entities previously entered into a distrusted entity blacklist or the like), and unknown entities (such as unknown people walking near the secured area). The smart controller can operate with higher accuracy and precision for achieving a desired outcome where these three entities, or at least one of these three entities, are identifiable and the smart controller can utilize identifying information associated with the entity to achieve outcome.

As described herein, the sensor (or another sensor located in proximity to the location of the secured area) can detect a nearby entity and capture information associated with the nearby entity. The sensor can include a visual sensor, such as a camera generating a video feed. The camera can be statically mounted such that the sensor captures a fixed point of view or dynamically mounted and movable between different points of view. In some implementations, the sensor can have a dormant mode and an active mode triggered in response to movement or another triggering action. Once in the active mode, the sensor can capture data associated with the detected movement. The sensor can provide the captured data to a processor, such as a processor of the smart controller.

The processor can process the data captured by the sensor to determine an identity status of the nearby entity (e.g., known v. unknown, entrusted v. distrusted, etc.) and cause a control operation of the access control system based on the determined identity status. For example, where the sensor detects and captures information associated with an unknown entity, the processor can determine the identity status as unknown and cause the access control system to secure a movable barrier. Where the associated movable barrier is a lockable device (such as a door lock), the processor can cause the door lock to move from an unlocked state to a locked state or confirm the door lock is in the locked state where the door lock was previously (already) locked. Where the associated movable barrier is a garage door, the processor can cause a movable barrier operator associated with the garage door to move the garage door from an open state to a closed state or confirm the garage door is in the closed state where the garage door was previously (already) closed. That is, the smart controller described herein can automatically cause the secured area to reconfigure to and/or remain in a secured state in response to detecting an unknown entity. Similarly, where the entity is a known, distrusted entity, the smart controller can automatically cause the secured area to reconfigure to and/or remain in the secured state in response to detecting the known, distrusted entity. In some instances, the smart controller can further take an additional action in response to detecting a known, distrusted entity. For example, the smart controller may initiate a recording process to store sensor data associated with the interaction with the known, distrusted entity. The smart controller may also take an additional action of notifying the resident (e.g., the homeowner) of the presence of the known, distrusted entity. The smart controller may further notify authorities (such as police) in response to detecting the known, distrusted entity. In some instances, the smart controller may only notify the authorities and/or notify the resident in response to the known, distrusted entity taking a particular action. For example, where a known, distrusted entity merely passes by secured area without stopping, the smart controller may take a first action, such as causing the sensor data to be recorded and saved. However, where the known, distrusted entity stops (e.g., loiters) near the secured area or moves towards the secured area (e.g., walking up a driveway or sidewalk towards the secured area), the smart controller may take a second action different from the first action, such as notifying the authorities and/or notifying the resident. The smart controller may be configurable by the user to set rules and automations based on the specific needs of the user and the spatial configuration of the secured area.

Where the detected entity is a known, entrusted entity, the smart controller may take a different action than when the detected entity is unknown or known and distrusted. For example, when the detected entity is a known, entrusted entity, the smart controller may leave the movable barrier in an unlocked and/or open state. For instance, where a known, entrusted resident approaches an open garage, the smart controller can cause the garage door to remain in an open state to allow the known, entrusted resident to enter the garage. In some implementations, the smart controller may even be configured to cause the garage door to open in response to detecting the known, entrusted entity. Similarly, where the movable barrier is a door having an electronically controllable door lock, the smart controller can maintain the door lock in an unlocked state or even cause the door lock to move from the locked state to the unlocked state.

In some instances, the sensor may capture data indicative of two or more entities in the field of view. The processor can process the sensor data to determine a status associated with each of the entities in the field of view. By way of example, one of the entities may be an entrusted, known entity and another one of the entities may be an unknown or known, distrusted entity. In response to identifying multiple entities in the field of view where the multiple entities include both a known, entrusted entity and another entity other than a known, entrusted entity, the smart controller can use a logic map or other determination structure to inform a control decision. For example, where the known, entrusted entity is approaching the movable barrier and the other entity is not approaching the movable barrier, the smart controller may keep the movable barrier open for the known, entrusted entity. The smart controller may initiate closure of the movable barrier after determining that the known, entrusted entity is within the secured area delimited by the movable barrier. For example, the smart controller may wait a period of time after the known, entrusted entity exits the field of view prior to instructing closure of the movable barrier. The period of time may be defined by a time-out operation, such as, for example, ten (10) seconds, five (5) seconds, or the like. Alternatively, or in addition, the smart controller may monitor further action by the other entity to determine whether the other entity is approaching the secured area. If the other entity starts to approach the secured area, the smart controller may initiate closure of the movable barrier, regardless of a status or presence of the time-out operation. Yet other determination structure can be used.

In some implementations, the determination structure can be adjustable, such as for example, by the account holder (e.g., the homeowner). For example, the homeowner can set a risk factor or select between a plurality of operating modes with various levels of risk avoidance. The risk factors may include, for example, a minimal response threshold, a medium response threshold, and a maximum response threshold. The minimal response threshold can correspond with minimal action to be taken by the smart controller (e.g., maximum time-out operation period, high threshold for initiating a notification to the user and/or police, etc.); the maximum response threshold can correspond with a maximum action to be taken by the smart controller (e.g., minimum time-out operation period, low threshold for initiating a notification to the user and/or police, etc.); the medium response threshold can be therebetween. In an embodiment, the risk factors can be selectable using a digital toggle which slides by user input on a display screen of a user device. Other user inputs may include physical buttons, dials, switches, or the like. In an embodiment, the user device can run an application that permits the user to select the risk factors. The application can provide guidance on setting the risk factors. For example, the application can provide examples where each risk factor response threshold may be most applicable. By way of example, the maximum response threshold may be best suited for urban environments with heavy foot traffic while the minimum response threshold may be best suited for rural environments with minimal foot traffic.

In some implementations, the sensor data may be split into two or more sections. For example, where the sensor is a camera mounted to or integral with a garage door operator, the field of view of the camera may be broken into a plurality of sections including, at least, a first section associated with a first portion of the visual data and a second section associated with a second portion of the visual data. The first portion of the visual data may be a lower section of the visual data, such as but not limited to a lower half of the visual data, and the second portion of the visual data may be an upper section of the visual data, such as but not limited to an upper half of the visual data. Visual data associated with the first portion of visual data may correspond to a captured location relatively close the garage door whereas visual data associated with the second portion of visual data may correspond to a captured location relatively further from the garage door. That is, the first portion of the visual data may correspond to an area between the garage door and the second portion of the visual data. In an embodiment, the first portion can be set to an internal area of the garage and the second portion can be set to an external area of the garage. By defining depth, the smart controller can process decisions with finer resolution granularity, permitting the smart controller to take actions not only based on identity status but also determined actions (e.g., is the entity approaching the movable barrier, moving away from the movable barrier, inside of the secured area, etc.). In another implementation, the first and second portions of the visual data can be laterally offset from one another, such as for example, a left section of the visual data and a right section of the visual data. Where, for example, the movable barrier is disposed at a particular lateral side of the field of view, the delineation of left and right sections may serve as a depth controller, allowing the smart controller to take action based on determined action of the entity (e.g., is the entity approaching the movable barrier, moving away from the movable barrier, etc.). Yet other sectional breakdowns are possible, including for example diagonal section breaks and/or the inclusion of three or more sections within the sensor data. In some implementations, such as where the secured environment includes complex spatial constraints, the greater the number of sections in the sensor data, the finer the granular decision making process by the smart controller. For example, where the sensor data captures multiple movable barriers, the use of additional sections, e.g., zones, in the sensor data may allow the smart controller to distinguish between actions taken by the detected entity with respect to the different movable barriers.

In an embodiment, the smart controller may permit a user to manually define the sections within the field of view. For instance, the user can select boundary locations associated with the camera field of view to establish a zone. The user can drag the boundary locations to customize the size and/or shape of the section. In another embodiment, the smart controller may automatically generate (or at least suggest) the location(s) where sections of the field of view should be divided. For example, the sensor data may be processed using computer vision algorithms to detect and interpret landmarks and obstacles. Additionally, the sensor data may be processed using image processing model or other image processing techniques.

The smart controller may employ one or more algorithms or machine-learning models to identify both landmarks and boundaries between sections within the sensor data. By way of non-limiting example, the smart controller may first recognize landmarks such as the layout of the garage or other secured area. This may include the identification of physical boundaries within the secured area, such as walls, fences, changes in terrain, clear color or shade boundaries, and the like. The smart controller may conduct a spatial analysis to group and categorize sections of the area into a plurality of zones, including a first zone, a second zone, and the like. In an embodiment, the plurality of zones can include less than four zones or greater than four zones. Grouping and categorization may be based on proximity to landmarks, containment within boundaries, or other spatial relationships identified through the analysis. In a non-limiting example, the first zone may be categorized by its containment within the boundaries of the garage. In a second non-limiting example, the second zone may be categorized by its location relative to the movable barrier. The result of the grouping and categorization process may include a map or visual representations of each zone of the plurality of zones.

In an embodiment, a plurality of zones may be identified by tracing on an image associated with the sensor data. The sensor data may be examined to identify distinctive landmarks, obstacles, and features. These features may serve as initial reference points for understanding the spatial layout of the area. The smart controller may display the images to a user via a user device. The smart controller may provide instructions to the user to outline one or more zones of the plurality of zones on the provided image. This may include prompting the user to trace or digitally outline specific landmarks that may be used to identify the boundaries between each zone of the plurality of zones. Alternatively, the user can move a boundary marker or box to correspond to a desired zone placement. In some instances, the processor may smooth or adjust the boundary marker or box. Tracing may define borders that separate one zone from another zone, such as the first zone from the second zone, based on the observed features and characteristics at each of the zones. Each traced boundary may encapsulate at least one zone of the plurality of zones within the image, facilitating clear demarcation and categorization. Setting the boundaries between the plurality of zones can be completed manually and/or through one or more automated algorithms.

It may be desirable for the user to manually capture image data of the environment and/or the nearby environment, parking spaces within the secured area, and the like. In some instances, the smart controller may determine whether additional sensor data is desirable. For example, the smart controller can compare already-obtained sensor data (e.g., image data obtained from a camera associated with the movable barrier operator or a separate image capture device) against a threshold value to determine whether sufficient image data exists. Where sufficient image data exists, the smart controller can then perform the steps and methods described herein. Conversely, where the comparison of already-obtained sensor data to the threshold value is determined to be unsatisfactory, the smart controller can cause the user to capture additional images. The smart controller may transmit detailed instructions to the user through a user device (such as a smart phone, tablet, etc.) for generating image data of the structure. For instance, the instructions may include the location or GPS coordinates where images of the structure should be captured. This may include instructions to generate image data looking into the structure while standing near the movable barrier. Instructions might also include guidance on optimal angles for capturing key features of, or associated with, the structure. Recommendations on ideal lighting conditions, focus settings, depth of field parameters, positioning, angle, lighting, and the like can also be included in the detailed instructions.

In some implementations, the sections (zones) can be stored locally, e.g., at the movable barrier operator, at the smart controller, at the camera, or the like. In other implementations, the sections (zones) can be stored remotely, e.g., at a remote server accessible by the smart controller. In some instances, the sections (zones) may be stored both locally and remotely. The smart controller may primarily rely on local or remote data and query the other data source only when an issue arises.

Establishing identity status of the entity may be performed locally, e.g., at the smart controller or remotely, e.g., at a remote server or other remote computing device. One or more processors receive sensor data, such as visual data from a camera, process the data, and analyze aspects of the processed sensor data to identify a status of the entity. Analyzing aspects of the sensor data can be performed, for example, by an image processing model. The image processing model may include a machine learning model. In some implementations, one or more machine learning models can include models such as neural networks (e.g., deep neural networks) or other types of machine-learned models, including non-linear models and/or linear models. Neural networks can include convolutional neural networks, feed-forward neural networks, recurrent neural networks (e.g., long short-term memory recurrent neural networks), or other forms of neural networks. Additionally, the machine learning model may include one or more transformer models. The machine learning model may include a convolutional neural network, a detection model, a natural language processing model, a segmentation model, a classification model, an augmentation model, a generative model, a discriminative model, and/or one or more other model types. The machine learning model can receive visual data captured by the camera and determine identity status of the entity detected in the visual data.

In one implementation, the sensor data may undergo a re-identification process through which the identity status is determined and the smart controller causes control of the access control system based on re-identifying the known identity status of the entity. The re-identification process generally determines the identity status using one or more techniques and attempts to re-identify the determined identity status using the sensor data. For example, where a known, entrusted resident exits their household through a garage having a camera associated with a garage door operator, the processor can determine one or more characteristics of the resident and associate the one or more characteristics with the known, entrusted entity. Due to the resident exiting the household, the processor may automatically associate the resident as a known, entrusted entity, i.e., based on their previous access to the household it is assumed that further access is permissible. However, given that the resident may walk away from the household without turning their face to be seen by the camera of the garage door operator, the processor may capture the one or more characteristics to identify the resident. By way of non-limiting example, these characteristics can include one or more of height of the detected entity, an estimated weight or lateral dimension of the detected entity, clothing style, clothing color, inclusion of a carried and/or worn accessory (e.g., a hat, a tool such as a broom or rake, etc.), gait, or another biometric attribute or indicia. These characteristics may be stored to identify the entity for re-identification. For example, the characteristics can be stored as a profile associated with a known, entrusted entity. The profile may be generated in response to identifying the entity and may not be specifically associated with the resident themselves. That is, the profile need not be tied to a specific resident of the household but may only be tied to an identity status (i.e., known v. unknown and trusted v. distrusted). The profile may be stored for a particular duration of time (e.g., ten minutes, one hour, one day, one week, etc.), until a particular action occurs (e.g., the entity is re-identified and the smart controller determines the entity has reentered the secured area), stored indefinitely, or the like. In an embodiment, the profile may be stored for a duration of less than one day, such as less than six hours, such as less than five hours, such as less than four hours, such as less than three hours, such as less than two hours, such as less than one hour. As the profile uses characteristics which may change frequently over time (such as clothing style and color), storing profiles for long periods of time is unnecessary. Frequent rollover of profiles may increase smart controller functionality and precision.

After a profile is generated, when the entity is subsequently detected by the sensor, the entity is able to identified as a known, entrusted entity by comparing the entity to the profile. In this regard, when a resident exits their house for a relatively short duration of time (e.g., less than six hours), the smart controller can prevent the smart controller from locking the house in response to again detecting the resident approaching the house. For example, where a resident exits their garage to bring a garbage can to the curb, the smart controller may re-identify the resident upon reapproaching the house and mitigate smart control securing automation, thereby preventing the resident from being locked out of their house.

In the above example, re-identification was initiated in response to a camera associated with a garage door operator, however such re-identification may occur through other means. For example, in some implementations a homeowner may include an internally-facing camera disposed at a door. For instance, the homeowner may have a security system with a camera that captures sensor data from an interior of the household. The camera may even capture facial identification as an entity is approaching and/or walking out of the door. In these instances, the re-identification process may occur in view of the sensor data captured prior to exiting the household. For example, the sensor data from the internally-facing camera may be processed to create a profile which can be used in the same or similar manner as described above. Alternatively, the capturing of the entity by the internally-facing camera may trigger another sensor (such as the garage door camera or an exterior camera) to capture biometric attribute(s) and/or indicia information used to determine a profile of the entity for purpose of re-identification. In other implementations, the household door may be integrated into the smart controller such that when the door is opened and the internally-facing sensor captures information associated with the entity, the profile is generated. In this regard, the entity profile only generates when the smart controller can confirm egress of the entity from the household. Yet other configurations and combinations of profile generation and re-identification are possible as described herein.

The re-identification process defined herein increases accuracy and precision of the smart controller, permitting enhanced operating capacity and household security without compromising access to known, entrusted entities, such as homeowners, residents, guests, and the like. In some implementations, the smart controller may be selectively controlled from a smart device, such as a smart phone running an application communicating with a remote server (e.g., a manufacturer’s server). Using the smart device, an account holder (such as the homeowner) can modify (control) access characteristics including, for example, adding entrusted entities to the smart secure functionality, modifying (adjusting) sensitivity and/or zones associated with the sensors, modifying (setting up) device integration such as which sensor data triggers profile generation and how, or the like. By controlling the individual factors associated with smart control, the account holder is able to easily configure the smart controller to their particular situation accounting for spatial considerations, desired security settings, and the like.

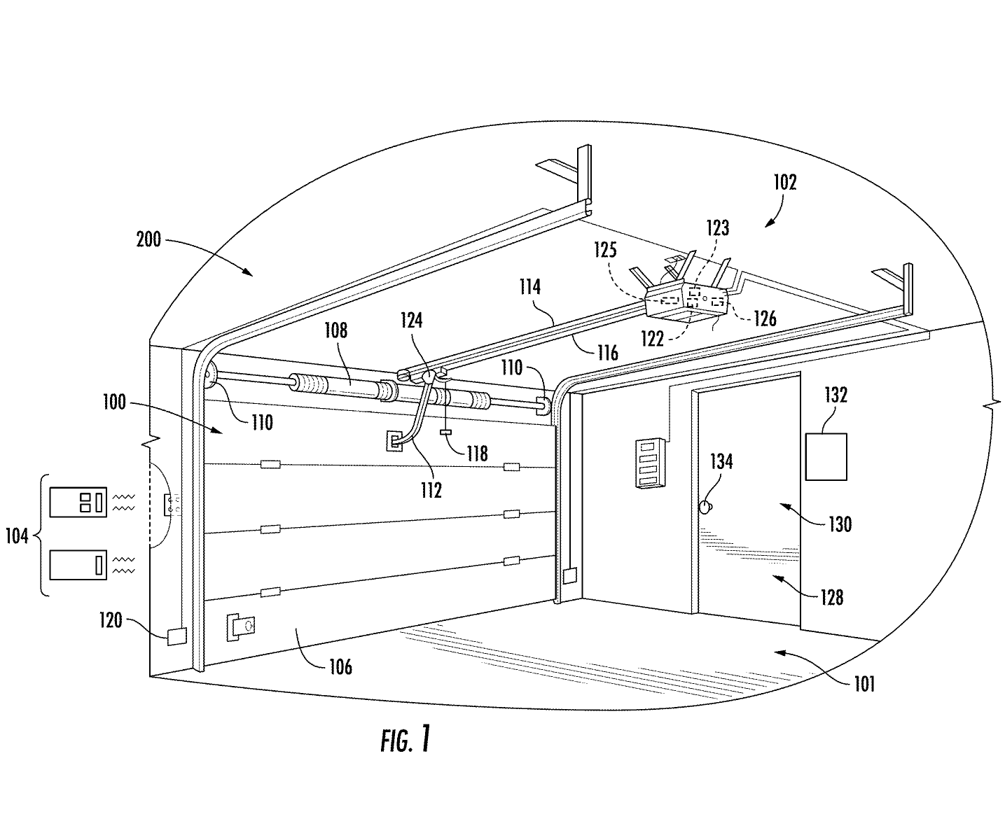

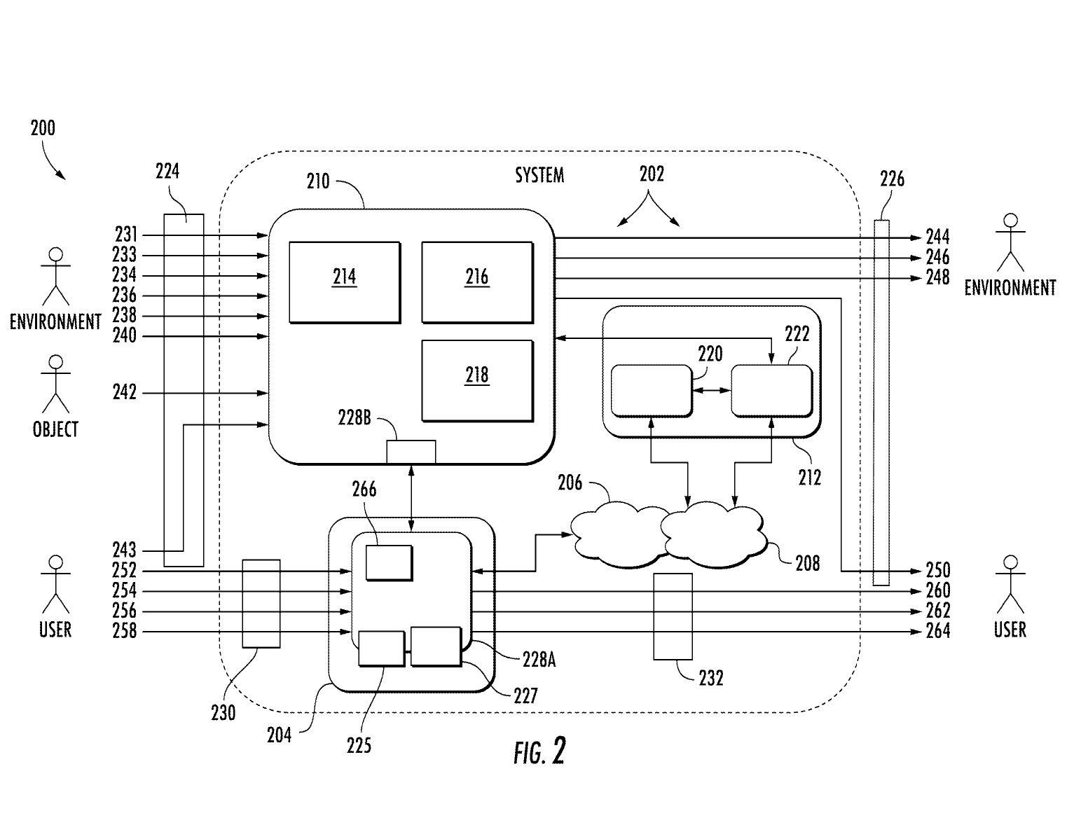

Referring now to FIG. 1, an access control system 200 is provided that includes a movable barrier operator system 100 for operating a movable barrier such as a garage door 106 that limits access to a secured area, such as a garage 101. In one embodiment, the movable barrier operator system 100 includes a movable barrier operator, such as a garage door operator 102, and one or more remote controls such as a transmitter 104. The one or more remote controls may also include, for example, a user device 204 (see FIG. 2) such as a smartphone, a laptop computer, a tablet computer, a wearable device, an in-vehicle device such as an infotainment system coupled to an in-vehicle transmitter, a keypad external to the garage 101, a wall control, a visor-mounted remote control, and/or a handheld transmitter such as a key fob. The garage door operator 102 includes an electric motor 122, communication circuitry 123, and a control circuit (including a processor 125 and a memory 126). The processor 125 may include, for example, a microprocessor, a system-on-a-chip, an application specific integrated circuit (ASIC), and/or a field programmable gate array (FPGA). The processor 125 can be one processor or a plurality of processors that are operatively connected. The memory 126 may include, for example, an electrical charge-based storage media such as EEPROM or RAM, or other non-transitory computer readable media such as an optical or magnetic-based storage device. The memory 126 can store information that can be accessed by the processor 125. For instance, the memory 126 (e.g., one or more non-transitory computer-readable storage mediums, memory devices) can include computer-readable instructions that can be executed by the processor 125. The instructions can be software, firmware, or both written in any suitable programming language or can be implemented in firmware or hardware. Additionally, or alternatively, the instructions can be executed in logically and/or virtually separate threads on processor 125. For example, the memory 126 can store instructions that when executed by the processor 125 cause the processor 125 to perform operations such as any of the operations and functions as described herein.

In some embodiments, the garage door operator 102 includes a rail 116 and drive member 114 such as a chain, belt, or screw driven by the motor 122 relative to the rail 116. The electric motor 122 in cooperation with the drive member 114 is operable to move the garage door 106 between open and closed positions. For example, a trolley 124 is coupled to the drive member 114 as well as an arm 112 that is attached to the garage door 106. The motor 122 shifts the trolley 124 back-and-forth along the rail 116 to lift and lower the garage door 106. A release mechanism 118 is coupled to the trolley 124 to allow the garage door 106 to be disconnected from the garage door operator 102 for manual operation such as during a power failure.

The movable barrier operator system 100 includes a drum and cable mechanism 110 that is attached to the garage door 106. The drum and cable mechanism 110 includes a drum and a corresponding cable on each side of the garage door 106. The cable is paid out from and wound up onto the drum when the garage door 106 is respectively lowered and raised. The drum and cable mechanism 110 couples to a counterbalance such as a torsion spring 108 that assists in lifting the weight of the garage door 106 and enables the garage door operator 102 to open or close the garage door 106 via movement of the trolley 124. In some embodiments, an optical device such as a photo eye system 120 senses an obstruction (e.g. object and/or a human) that may be in the path of the garage door 106 as the garage door 106 closes.

As seen in FIG. 1, the garage 101 can include an interior access door 128 disposed between an interior of the garage 101 and an interior of a home and selectively restricting access from the garage 101 into the interior of the home. The access control system 200 includes a smart lock such as a door lock system 130 configured to lock and unlock the interior access door 128 in response to receiving external command signals or identifying the presence or non-presence of various access conditions. The door lock system 130 can also be included in other doors of the residence besides the interior access door 128 such as egress/ingress front, back, side, etc. doors as well as bedroom, bathroom, and other doors inside of the home. The door lock system 130 may include a knob with a lock, a deadbolt, or a lockset in some embodiments.

With continued reference to FIG. 1, the access control system 200 may include a communication bridge or hub 132 in the secured area. The communication hub 132 may facilitate communication between the garage door operator 102, door lock system 130, and/or a remote resource such as a server computer. The communication hub 132 may facilitate opening and closing of the garage door 106 and locking and unlocking of the door lock system 130 based on various detected conditions. As with the door lock system 130, the access control system 200 may include other components not shown in FIG. 1, such as cameras proximate to the front, rear, side, etc. doors or at other exterior and/or interior locations of the residence.

Turning now to FIG. 2, an example block diagram of the access control system 200 is provided. The access control system 200 includes a camera subsystem 202 and the user device 204 that communicates with a local area network 206 such a user’s home wired or wireless network and a wide area network 208 such as the internet. The camera subsystem 202 includes a camera system 210 and a server subsystem 212.

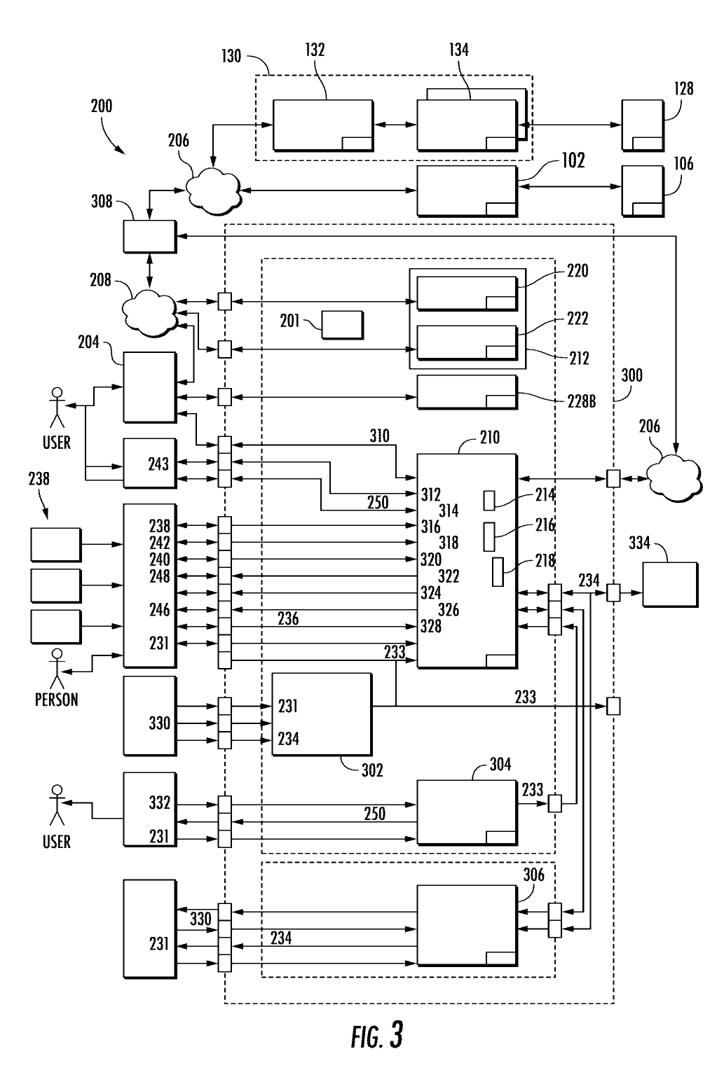

The camera system 210 includes a processor 214, a memory 216, and a communication interface 218. The processor 214 may include, for example, a microprocessor, a system-on-a-chip, an application specific integrated circuit (ASIC), and/or a field programmable gate array (FPGA). The memory 216 may include, for example, an electrical charge-based storage media such as EEPROM or RAM, or other non-transitory computer readable media. The communication interface 218 can include various different wired and wireless systems such as WI-FI, Bluetooth, cellular radio, ethernet etc. for use in electrically communicating with other components of the access control system 200, the movable barrier operator system 100, and/or the door lock system 130. The server subsystem 212 can communicate with the camera system 210 via the communication interface 218 and can include an access control platform component 220 and an image data analysis component 222 that electrically communicate with each other and the wide area network 208, such as the internet. The access control platform component 220 and/or the video server component 222 can be located local to the camera system 210 or remote. When located remotely, the access control platform server component 220 and/or the video server component 222 can include server computers that are located away from the residence and that communicate with the camera system 210 via the wide area network 208. When located remotely, the access control platform component 220 and/or the image data analysis component 222 can also include hardware components that are located at the residence and that utilize the local area network 206 to communicate with the camera system 210 (e.g. via an access control system hub 201 depicted in FIG. 3). As seen in FIG. 2, the camera system 210 also receives camera system inputs a and produces camera system outputs 226.

The user device 204 includes a processor 225 and a memory 227. The processor 225 may include, for example, a microprocessor, a system-on-a-chip, an application specific integrated circuit (ASIC), and/or a field programmable gate array (FPGA). The memory 227 may include, for example, an electrical charge-based storage media such as EEPROM or RAM, or other non-transitory computer readable media. The memory 227 can include programed instructions that when executed by the processor 225 operates an application 228A that can interface with other system components, such as an application 228B that runs on the camera system 210. The user device 204 can receive user device inputs 230 and can provide user device outputs 232.

With reference to FIG. 2, the camera system inputs 224 can include an environment input 231, an alternating or direct current power input 233 used to power the camera system 210, a hardware mounting interface 234 for mounting the camera system 210 or portions thereof at one or more locations of the residence, ambient lighting input 236, a visual input 238, an audio input 240 such as a microphone, motion input 242, and a reset configuration user input 243. The environment input 231 can include a temperature sensor that triggers one or more components or the entirety of the camera system 210 to enter a cool-down/standby mode when the ambient temperature detected by the temperature sensor is above a threshold temperature that could cause the camera system 210 to overheat. The environment input 231 may also include a gyroscope or gravity sensor that detects an orientation of the camera system 210 so that image correction may be performed if the camera system 210 is installed upside down. The environment input 231 may also represent the place/location/context in which the camera system 210 is installed and constitute a confluence of factors that affect aspects of the operation of the camera system 210 such as field of view, power source, mounting height/angle/location, etc.

The motion input 242 can include a motion specific sensor such as a passive infrared sensor, millimeter wave radar motion sensor, lidar, or similar sensor that facilitates waking up of an image sensor, processor, etc. of the camera system 210 from a low (or off) power state when motion is detected by the motion specific sensor to determine that motion has been detected within a region of interest via the visual input 238. In embodiments in which the camera system 210 utilizes a wired power source (i.e. not solely battery powered), the camera system 210 may record substantially continuously such that motion detection to wake up the camera system 210 is optional. Furthermore, in general the camera system inputs 224 include any detectable condition used to activate the camera system 210. As described herein, these conditions include motion from a person detected using visual input 238, motion from a heat source (e.g., wild animal, person, etc.) detected using the motion input 242, an audio signal detected using the audio input 240 (e.g., breakage of a pane of glass or similar), changing exterior lighting conditions detected using the ambient lighting input 236, and weather conditions such as snow reflection, rain, etc.

The camera system outputs 226 can include a night vision output 244 such as an infrared light, a visible light output 246 such as a light emitting diode (LED) or other illumination source, a sound output 248 such as a speaker, and a status indicator 250 of the camera system 210. The status indicator 250 can include an indicator physically present on the camera system 210 such as an LED or a display. The status indicator 250 can also include audio information output from a speaker of the camera system 210.

The user device inputs 230 can include network provisioning information 252 for connecting the user device 204 and/or the camera system 210 to the local area network 206, a camera management user input 254 for controlling operations of the camera system 210, a subscription management user input 256 for connecting the user device 204 and/or the camera system 210 to an access control platform via the local area network 206 and the wide area network 208, and a push to talk user input 258. The push to talk user input 258 can include a button (e.g., a virtual button shown on a screen of the user device 204) and a microphone of the user device 204. When the push to talk mode is activated, the audio received by the microphone can be relayed from the user device 204 to the camera system 210 and then be provided as the push to talk output 248. As seen in FIG. 2, the user device outputs 232 can include a live stream output 260, a recorded video output 262, and a notification output 264 each of which can be provided via a user interface such as displayed on a display 266 (e.g., a touchscreen or an augmented reality display) of the user device 204. The live stream output 260 can include a live display of the visual input 238 and/or the audio inputs 240 to the camera system 210. The recorded video output 262 can include one or more time shifted displays of prior versions of the visual input 238 and/or the audio input 240.

Turning now to FIG. 3, another example block diagram of the access control system 200 is provided. As seen in FIG. 3, the camera subsystem 202 can be a part of a larger vision system 300 and can additionally include a power supply 302 and a rechargeable battery 304. The vision system 300 can also include a flood light 306 in addition to the camera subsystem 202. The flood light 306 is, when activated, configured to illuminate an area in proximity to the camera system 210 to scare away or otherwise deter a potential intruder and assist with capturing video or static images in darker ambient light conditions. Further, as seen in FIG. 3, the access control system 200 can include a router 308, modem, or access point that manages the local area network 206 and provides a connection to the wide area network 208. Further still, the door lock system 130 and the garage door operator 102 can communicate with the access control system 200 via the local area network 206. Further still, the door lock system 130 can include a communication hub 132 and one or more controllable locksets 134. For example, a home may be provided with one communication hub 132 and controllable lockets 134 for the front, rear, and side doors of the home. The communication hub 132 receives commands or other information from the local area network 206 and communicates with each of the controllable locksets 134 via wireless signals such as a Bluetooth connection. In some embodiments, the communication hub 132 is omitted and the controllable lockset 134 communicates directly with the local area network 206.

As seen in FIG. 3, the user device 204 can communicate directly with the camera system 210 via local, short-range, point-to-point communications such as a Bluetooth connection 310. The Bluetooth connection 310 can be facilitated in part by the communication interface 218 of the camera system 210. The camera system 210 additionally includes a reset button 312, at least one status LED 314, a lens and image sensor 316, a passive infrared sensor 318, a microphone 320, a speaker 322, at least one infrared light emitting diode 324, a spotlight 326, and an ambient light sensor 328.

In operation, the reset button 312 is activatable by the reset configuration user input 243, and when activated can reset the camera system 210 to a default or factory condition. The at least one status LED 314 can be configured to output the status indicator 250 to inform a user of a current operating status of the camera system 210. The lens and image sensor 316 are configured to capture image data, such as video and/or static images, of a field of view in a region proximate to the camera system 210. The camera system 210 can then store the captured image data to the memory 216 and/or the image data analysis component 222 of the server subsystem 212. The captured image data corresponds to the visual input 238, which as seen in FIG. 3 can include various elements such as a car license plate, an open or closed status of a gate, an open or closed status of a door (e.g. the garage door 106 or the interior access door 128), a person, etc. The passive infrared sensor 318 can receive the motion inputs 242. In some embodiments, the passive infrared sensor 318 can work in conjunction with the infrared light emitting diode 324 to detect motion in proximity of the camera system 210 based on changes in infrared radiation in proximity of the camera system 210. The spotlight 326 can be configured to output the visible light display 246 and in some embodiments can be configured to output light in a smaller area than the flood light 306 or when the flood light (which may be optional in some embodiments) is not active or included. The ambient light sensor 328 can be configured to measure the ambient lighting input 236. In response to the measurement of the ambient lighting input 236 by the ambient light sensor 328, the camera system 210 can modify settings of the lens and image sensor 316 to ensure that the image data captured by the camera system 210 are properly exposed to record events occurring in the field of view of the camera system 210.

As seen in FIG. 3, in some embodiments, the power input 233 to the camera system 210 can be a direct current power input. In such embodiments, the power supply 302 can include an alternating current to direct current converter that receives and then converts external alternating current 330 to the direct current input 233. The rechargeable battery 304 can also provide the direct current input 233 and, in some embodiments, can be charged via an external direct current input 332 and/or from the power supply 302. The flood light 306 can be powered from the external alternating current 330.

Further still, as seen in FIG. 3, the access control system 200 can include a housing 334 that accommodates the entire vision system 300 or at least the camera system 210, the power supply 302, the rechargeable battery 304, and the flood light 306. The housing 334 can integrate with the hardware mounting interface 234 to secure the larger vision system 300 in place. Examples of mounting locations for the housing 334 include a wall, sofit, electrical junction box, etc.

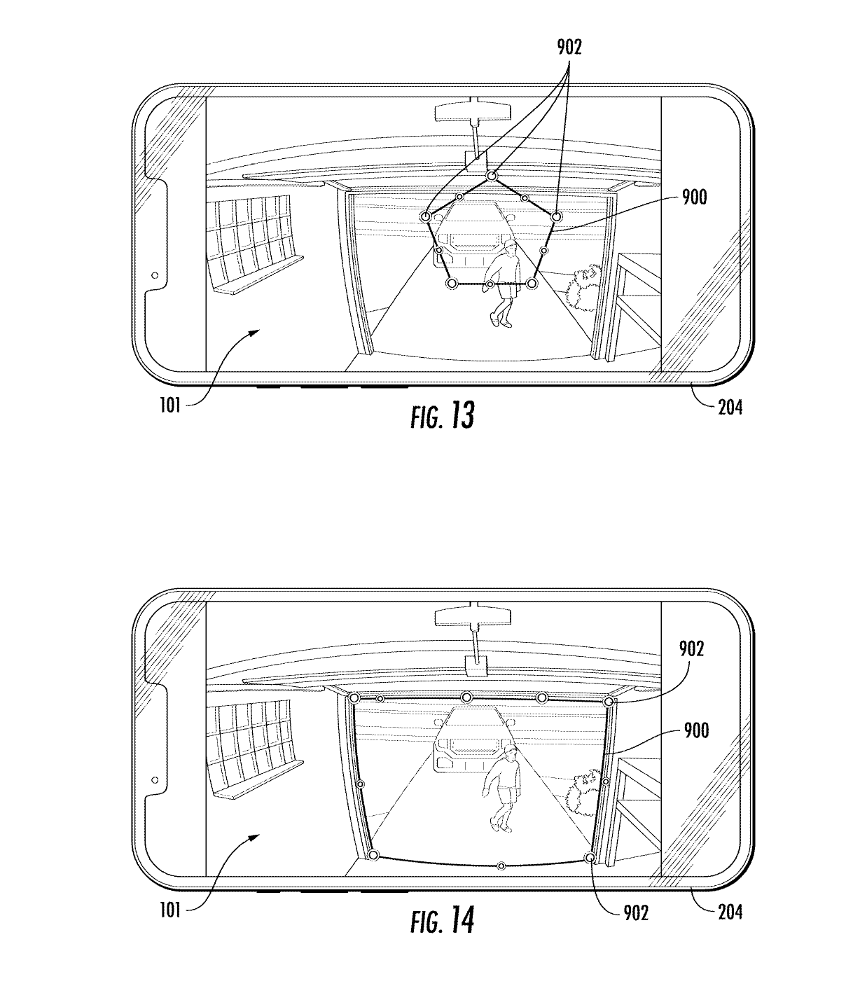

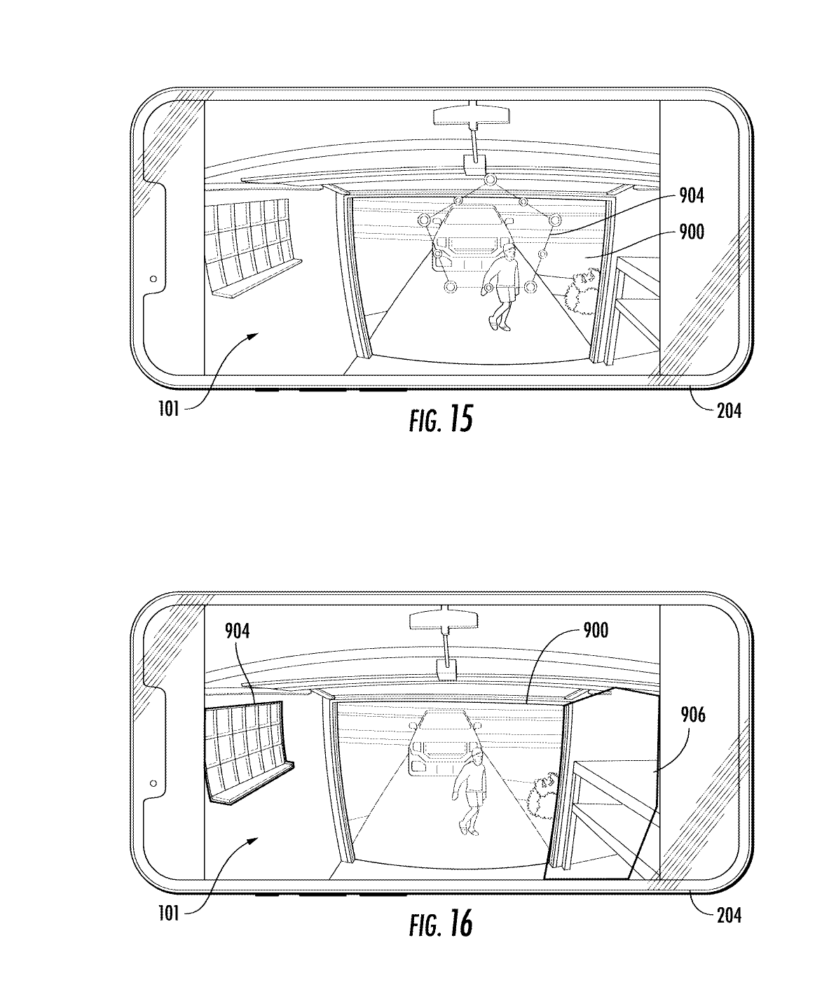

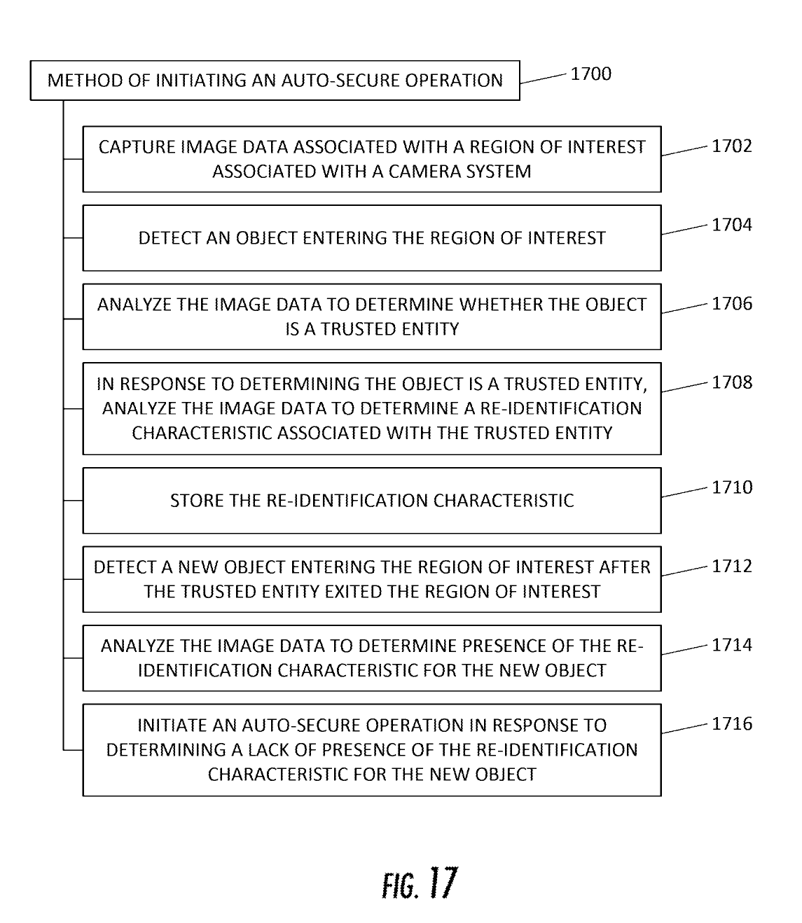

In general, the access control system 200 is programmed with an auto-secure operation to automatically close the garage door 106 and automatically lock the door lock system 130 when an unknown person is detected within a field of view of the camera system 210 or within some other predefined zone within the field of view. In some embodiments, a region of interest 900 (see FIG. 13) of the field of view of the camera system 210, i.e., a zone, can be set by a user or by a system component. For example, as shown in FIG. 13, the user device 204 can display an image captured using the camera system 210 of the garage 101 with an overlay of the region of interest 900 including a plurality of adjustable nodes 902 that can be dragged, traced via a stylus or human finger, or otherwise rearranged and/or otherwise moved to define a perimeter of the region of interest 900. In some embodiments, the perimeter of the region of interest 900 is initially a polygonal shape as shown in FIG. 13. As seen in FIG. 14, the initial polygon shape can be arranged to cover the entrance to the garage 101 by dragging the plurality of adjustable nodes 902. Furthermore, as shown in FIGS. 15 and 16, the access control system 200 can include additional regions of interest 904 and 906 that are arranged to cover different locations within the garage 101 such as a window area for the region of interest 904 and a storage area for the region of interest 906.

Furthermore, in some embodiments, the camera system 210 or other remote, network-based cloud components (e.g. server computer or middleware) connected to the camera system 210 can translate a user defined location of the altered nodes 902 into specific regions or pixel areas of the image sensor portion of the camera system 210. For movement detection or image analysis purposes discussed below, any region or pixel that contacts the user defined location of the altered nodes 902 will be considered as a part of the region of interest 900, 904, 906, etc.. Data representative of the region of interests 900, 904, 906, etc. can be stored on the camera system 210 and/or in a remote computing resource such as the image data analysis component 222, access control platform component 220, or a middleware processing apparatus or cloud server computer.

In some cases, the access control system 200 can include multiple different camera systems 210. In these embodiments, a region of interest can be generated for each of the camera systems 210. The precision of these regions of interest 900, 904, 906, etc. may be higher than a human eye can detect. When motion is detected inside the regions of interest 900, 904, 906, etc., computer vision-based operations as described below are used to analyze images captured by the one or more camera systems 210, and then apply interpretations of the analyzed images to predictive or decision making tasks such as sounding an alarm, turning on the flood light 306, and/or securing one or more access points of the residence or area. In some embodiments, any action taken based on these decision-making tasks is saved (e.g. remotely in the cloud or locally in one or more premises-based component) for later review.

The auto-secure operation utilizes the lens and image sensor 316 along with image processing operations stored in the memory 216 and/or in the access control platform component 220 to capture and analyze image data. The image processing operations can include computer vision techniques such as object detection, object tracking, and image analysis, to recognize if an unknown entity, hereinafter referred to as an unknown person, is detected in the field of view of the camera system 210. As used herein, an “unknown person” is an object within the field of view of the camera system 210 determined to be a person and not another object or creature but whose specific identity is not known or determined by the access control system 200. The access control system 200 may be configured to not specifically identify a person (e.g., to not employ a facial recognition technique or similar technique that determines whether a human is a particular human known as John Smith) in the field of view of the camera system 210, but rather determines the object is a person rather than a non-human animal, moving or stationary object, or vehicle as some examples.

In another embodiment, the access control system 200 may be configured to identify a person in the field of view of the camera system 210 as a known person such as by recognizing the person’s face or other biometric attribute, gait, clothing, or other indicia. The access control system 200 may therefore distinguish between an unknown person and a known person detected by the camera system 210. The access control system 200 may operate the auto-secure operation in response to the detected person being an unknown person but not operating the auto-secure operation in response to the detected person being a known person.

In some embodiments, the image processing operations can include a trained artificial intelligence program stored on the camera system 210 in the memory 216, at the access control platform component 220, or at some other location electrically accessible to the access control system 200. This trained artificial intelligence program can receive the images from the lens and image sensor 316 and identify when features present in the images correspond to the unknown person.

The auto-secure operation allows users to setup automatic rules to close the garage door 106 and lock the interior access door 128 or other door employing a door lock system 130. The access control system 200 may send alert notifications to one or more user devices associated with the residence based on the detection of the unknown person. The auto-secure operation proactively secures one or more access points of the residence while the alert notifications communicate the event to a person not present at the residence.

In some embodiments, the auto-secure operation is predicated on the detection of the unknown person in a region of interest in the field of view of one or more camera systems 210 during certain preconfigured or default time periods. For example, a user can setup the access control system 200 to have the auto-secure operation operable between 9pm and 7am while the user’s family is asleep. Alternatively or additionally, the access control system 200 can be configured to automatically close and/or lock all open doors at a predetermined auto-lock time, such as 9pm. In some embodiments, the preconfigured time period and/or the auto-lock time can be set by user input on the user device 204 via the application 228A.

As noted above, in some embodiments the access control system 200 determines that a person in the field of view of the camera system 210 is an unknown person without determining the identity of the person. In other words, the access control system 200 is operating the camera system 210 to detect a person in the field of view, whether the person is authorized or otherwise known to the access control system 200. In these embodiments, the access control system 200 may employ a time-out operation for the auto-secure operation to prevent locking out of a resident or a guest when the resident or guest leaves the residence for a short period of time but then returns, such as for collecting postal mail or a parcel from a mailbox or receptacle, or taking trash to a garbage can. The time-operation provides a set or adjustable time period for a person to be detected by the camera system 210 but without the access control system 200 initiating the auto-secure operation.

More specifically, the access control system 200 can activate the time-out operation when the access control system 200 detects a person entering the field of view of the camera system 210 from the inside of the home, that is, the time-out operation being active for a person who is known/trusted (e.g. a resident/occupant) and not an unknown person such that the resident does not become locked out unintentionally. In embodiments where the auto-secure operation is limited to a preconfigured time period, e.g., 9pm - 7am, the time-out operation can be utilized during the preconfigured time period. Furthermore, the access control system 200 can utilize geofencing, knowledge of a door being opened from the interior of the residence (i.e. indicative of high probability that the individual opening the door is a known/trusted person and not an unknown person), and/or the garage door operator 102 being actuated from an interior keypad to identify that a person in the field of view of the camera system 210 entered the field of view from inside the home. For example, if a resident wants to take out the garbage, the resident can open the garage door 106 using a wall control in the garage 101 and the access control system 200 will determine that the garage door 106 was opened from inside the residence. The access control system 200 then triggers the time-out operation to inhibit operation of the auto-secure operation and associated closing of the garage door 106 while the resident is outside of their home. In some embodiments, the time-out operation can disable the auto-secure operation for a short period of time (e.g. approximately 5-15 minutes). However, in some embodiments, the time-out operation can disable the auto-secure operation until another triggering event is detected such as the garage door 106 being closed or a door equipped with the door lock system 130 being closed.

In some embodiments, the time-out operation can be replaced or supplemented with a re-identification operation. The time-out operation, while suitable for most user interactions, may be insufficient alone for certain use cases. For example, where the resident/occupant is taking out trash, the use of a short timer (e.g., less than 5 minutes) may be sufficient to provide the resident/occupant with enough time to return without the garage door 106 closing while the resident is outside of their home. However, activation of the auto-secure operation may trigger closure of the garage door 106 where the resident/occupant is outside for a substantially longer period of time. For example, the resident/occupant may remain outside longer than expected while talking to a neighbor, tending to yardwork or maintenance, or the like. It is undesirable for the auto-secure operation to trigger closure of the garage door 106 in these conditions where no danger of entry by an unknown and/or distrusted person occurs. To prevent the auto-secure operation from undesirably triggering in these instances, the access control system 200 can activate the auto-secure operation in response to a re-identification operation.

Re-identification occurs where the access control system 200 re-identifies a person, including capturing characteristics associated with the person and then using the captured characteristics to recognize the person, without necessarily identifying the person (e.g., to not employ a facial recognition technique or similar technique that determines whether a human is a particular human known as John Smith). In some instances, re-identification can occur in view of personal identification (e.g., determining that a human is a particular human known as John Smith). This can occur, for example, using facial recognition. However, in many use cases such determination is not possible based on spatial constraints, particularly with respect to field of view restraints and lower image quality associated with the camera system 210. For example, where the camera system 210 is deployed in the garage 101 and faces away from an interior door in an outward direction, when a person leaves the household they frequently do not turn to face the camera, thus mitigating effectiveness of facial recognition techniques based on captured images. Similarly, when a person is wearing a hat, sunglasses, or other clothing that partially covers their face, facial recognition techniques may be rendered less effective, or even ineffective. Yet further, many residents take their trash and other material outside during the evening after returning from work when the garage 101 is in a low light condition, again rendering facial recognition techniques less effective. In this regard, the access control system 200 might mistakenly identify such a person as unknown, thereby undesirably triggering the auto-secure operation and locking a known/trusted person out of the home.

Re-identification may occur by detecting and identifying one or more characteristics of an assumed known/trusted person. The status of the person as known/trusted may occur in response to an existing condition. The existing condition can include, for example, a section or side of the field of view that the person enters the field of view, a direction of travel of the person entering and/or moving through the field of view, or the like. For example, when the person is first detected, i.e., enters the camera field of view, from a location determined to be from the house (i.e., not from a location external to the secured area), the person may be automatically assumed to be a known/trusted person. In response to detecting an assumed known/trusted person, the re-identification process can include identifying the one or more characteristics of that person. The identified characteristics can include, for example, one or more of a height of the detected person, an estimated weight or lateral dimension of the detected person, a clothing style or a clothing color worn by the detected person, inclusion of a carried and/or worn accessory (e.g., a hat, a tool such as a broom or rake, etc.), gait, or another biometric attribute or indicia. In some implementations, the characteristic(s) can be identified by the access control system 200 from a single image, such as from one image generated in a stream of images captured by the camera system 210. The access control system 200 can analyze aspects of the image, for example, by using an image processing model. The image processing model may include a machine learning model. In some implementations, one or more machine learning models can include models such as neural networks (e.g., deep neural networks) or other types of machine-learned models, including non-linear models and/or linear models. Neural networks can include convolutional neural networks, feed-forward neural networks, recurrent neural networks (e.g., long short-term memory recurrent neural networks), or other forms of neural networks. Additionally, the machine learning model may include one or more transformer models. The machine learning model may include a convolutional neural network, a detection model, a natural language processing model, a segmentation model, a classification model, an augmentation model, a generative model, a discriminative model, and/or one or more other model types. The machine learning model can receive visual data captured by the camera system 210 and determine the characteristic in response thereto. In some implementations, the machine learning model can be trained to identify particular characteristics and to ignore other characteristics. In an embodiment, the account holder (e.g., the resident with ownership) may be able to set the machine learning model to identify particular characteristics or provide a relative weighting or differentiation between different characteristics. For instance, households located in relatively colder weather where jackets are frequently worn may prefer relatively higher weighting of clothing color in view of the high probability the detected person is wearing a jacket or other articles of clothing which are subject to change positions and status (e.g., the detected person is more likely to open and/or close the jacket between the initial characteristic identification and the subsequent re-identification for triggering the auto-secure operation). Conversely, households located in relatively warmer weather may prefer relatively higher weighting of height or lateral dimension of the detected person as these factors are unlikely to change due to the detected person wearing fewer articles of clothing which may become changed between initial detection and subsequent re-identification.

The access control system 200 can store the identified characteristic(s) as part of a profile associated with the detected person. The profile can be saved locally or remotely and include the identified characteristic. The profile may not be tied to a particular person (e.g., the profile may not be registered as belonging to John Smith) but instead include a generic label, such as “Person 1”, “Detection 1”, “#1”, “A”, or the like. In other instances, the profile may include only the characteristic(s) without any label. In an embodiment, the profile is stored in memory as part of a ledger, a whitelist, a look up table, or another reference material (all referred to hereinafter as the ledger) which can be accessed by the access control system 200 for later re-identification. In an embodiment, the profile can be viewed by a resident, such as the account holder, for example, using a smart device. For example, the smart device can access the ledger to display to the user what current profiles are listed. The account holder can remove, edit, or add profiles. The account holder may further update settings associated with the ledger or profiles contained thereon. For example, the account holder may grant different privileges or authority to different profiles.

In an embodiment, the access control system 200 may update one or more of the profiles in response to a changed characteristic from an additional image generated by the camera system 210. For example, where the original image is determined to include a particular clothing style or shape having a certain pattern which is later determined from an additional image captured at a later time to be different, the access control system 200 can update the characteristic in view of the additional image data. Updating the characteristic may include replacing the original characteristic with the updated characteristic, supplementing the original characteristic with the updated characteristic, or the like. The updated profile can then be used for re-identification. In some instances, the account holder can set the threshold for characteristic updating. The account holder might change the threshold to be more stringent for maximum security or less stringent where lesser security is required. By way of non-limiting example, where the original image depicts a person wearing a red coat but later image data shows a person holding a substantially similar colored coat having a similar size and shape, the profile may be updated (depending on the threshold set by the account holder) to instead account of the handheld red coat. The original profile characteristic that the red coat is being worn may be replaced or supplemented. Where the profile characteristic is replaced, the person may not be later re-identified if the person puts the coat back on. By way of non-limiting example, re-identifying the red coat (or other detected characteristic associated with the wearer) can be performed in view of hue, saturation, relative size or shape, or other attributes associated with the detected characteristic. These attributes can be compared against the attributes stored in the ledger to determine whether updating is warranted.

In some implementations, the account holder can further define an assumption factor associated with re-identification. The assumption factor defines a threshold sensitivity for associating a determined characteristic with the detected person. For example, where the camera system 210 detects two similar people with similar characteristic(s), the assumption factor may determine if the two similar people are classified as the same person or different people based on how sensitive the assumption factor is set to. Where sensitivity is high, the access control system 200 can seek to maximize a number of datapoints (i.e., characteristic(s)) having similarity prior to determining the two detected similar people are the same person. Conversely, where sensitivity is relatively lower, the access control system 200 can form a determination that a person detected in two different images is the same person with relatively fewer datapoints, thereby reducing computational power required (thus allowing the computation to occur at a relatively less powerful device). However, the risk of error is greater where the sensitivity is set relatively lower. In some implementations, the access control system 200 can automatically configure sensitivity and/or adjust a set sensitivity in view of one or more factors, such as how many people are detected by the camera (e.g., in high-density urban environments, sensitivity may be set relatively higher than in rural environments), historical data, an error log established in view of incorrect closure of the movable barrier, and the like.

In an embodiment, characteristic identification can occur during a finite duration of time after the person is initially detected. For example, a timer can be triggered by the person entering the field of view of the camera system 210. The timer can define an amount of time in which one or more images is generated for characteristic identification, after which point the characteristic is fixed, i.e., further images are not used to determine the characteristic. The timer can be, for example, one (1) second, five (5) seconds, ten (10) seconds, twenty (20) seconds, one (1) minute, or the like. In some instances, the characteristic is not added to the ledger until expiration of the timer. In other instances, the ledger can be modified as the characteristic is further clarified through additional image processing. After expiration of the timer, further detection of the person may be processed as part of re-identification rather than characteristic identification.

In an embodiment, the profile, including the characteristic, can remain on the ledger during a re-identification period in which re-identification of the person is possible. The re-identification period defines a duration of time throughout which the access control system 200 may re-identify the person based on the characteristic in the profile. For example, the re-identification period can be two (2) hours, four (4) hours, six (6) hours, twelve (12) hours, or even twenty four (24) hours. After the re-identification period expires, the profile is no longer active and may not be used for the re-identification operation. In some instances, the profile is deleted from the memory after expiration of the re-identification period. In this regard, memory requirement for the re-identification operation is minimal. In other instances, the profile is moved from an active portion of the ledger to an inactive portion of the ledger upon expiration of the re-identification period. Regardless, once the re-identification period expires, the characteristic is no longer comparable for purpose of overriding the auto-secure operation.

As previously described, the access control system 200 can use the identified characteristic to override the auto-secure operation. Overring the auto-secure operation prevents the access control system 200 from locking the resident or other known/trusted person from the home. In an embodiment, the access control system 200, upon the camera system 210 detecting a person entering the field of view, e.g., from a non-secure side of the field of view, can process the data from the camera system 210 to determine one or more characteristics of the detected person. In some implementations, the access control system 200 can determine the one or more characteristics without deference to information contained in the ledger (i.e., the characteristic can be determined without preferential bias to stored characteristics). In this regard, the access control system 200 may provide a new analysis without seeking particular attributes from the ledger for comparison. In other implementations, the access control system 200 may query the ledger for stored characteristics which are then specifically sought in the captured image. For example, where the ledger stores a profile indicating presence of a grey jacket with a certain dimensional attribute, the access control system 200 can initially and/or preferentially analyze the image data for a grey jacket having the dimensional attribute. This may reduce processing requirements on the access control system 200, provide quicker re-identification, and increase overall speed and effectiveness of the access control system 200 in performing the auto-secure operation when necessary. The access control system 200 may compare the characteristic on the ledger with the detected characteristic or person detected in the field of view of the camera system 210.

In some implementations, comparing is performed in the sensor data itself. For example, the access control system 200 can analyze and compare the image associated with the initial characteristic determination to the re-identification image. The access control system 200 can use a comparison tool or software to determine similarities and/or differences between the two images. In other implementations, comparing is performed using metadata, i.e., extracted data that is derived from the image data. For example, the ledger may store the characteristic using a descriptive nomenclature (though not necessarily discernable or readable by a human), which can be compared to a characteristic of the person detected for re-identification where the characteristic uses the same descriptive nomenclature. In this regard, derivative information may be used for the comparison. In yet other implementations, comparing is performed in view of both the sensor data and the metadata. In some instances, one of the sensor data or metadata is used to form a preliminary determination which is then confirmed by the other of the sensor data or metadata. In other instances, the sensor data and metadata are each given a relative weighting in a determination. In some instances, the data associated with the re-identification, or a sub-process associated therewith, can be saved for later inspection, such as part of an error processing event, or used to improve re-identification.

In an embodiment, the access control system 200 is configured to enter a retrain mode when the re-identification process is determined to fall below a threshold accuracy. In some implementations, the access control system 200 automatically enters the retrain mode based on the threshold accuracy condition and a current accuracy condition. In other implementations, the account holder can cause the access control system 200 to enter the retrain mode. In retrain mode, the access control system 200 may create one or more feature maps or threshold value mapping schemes using images captured by the camera system 210. Data captured by the access control system 200 in retrain mode may be entered into the machine learning model(s) to allow for increased accuracy.

In an example operation, the camera system 210 detects movement of an object in the region of interest of the field of view of the camera system 210 either using the passive infrared sensor 318 and/or the lens and image sensor 316. This movement triggers the access control system 200 to reconfigure from a monitoring mode to an attempted access mode and begin a recording event whereby the lens and image sensor 316 captures images and communicates associated image data to the image data analysis component 222. The access control system 200 determines whether the object is an unknown person by processing the image data locally at the camera system 210, at the image data analysis component 222, at the access control platform component 220, or various combinations thereof. The image data analysis component 222 or the camera system 210 then informs the access control platform component 220 if an unknown person has been detected. Then, if notification features have been enabled, such as by using the client application 228A, the access control platform component 220 sends a notification of the recording event to the user device 204. Additionally, in some embodiments, the detection of movement can initiate broadcast of other alerts such a chime or warning sound from the speaker 322, turning on of the flood light 306, out-dialing a phone call to play a prerecorded message for a security company and/or emergency service provider (e.g. police, 911 call center or other public safety answering point ‘PSAP’), etc. In some embodiments, the other alerts can also include automated messages played from a loudspeaker of the access control system 200 that notifies the unknown person they have been detected and that the home has been secured when the access control system 200 detects the unknown person.

In response to the camera system 210 detecting movement, the camera system 210 utilizes image processing operations to determine whether the movement was caused by an unknown person or some other object such as a vehicle, landscaping element, or non-human animal. When the camera system 210 determines that an unknown person is present, the camera system 210 informs the image data analysis component 222 likewise and provides an image of the unknown person to the image data analysis component 222. The image data analysis component 222 informs the access control platform component 220 that the unknown person was detected and provides the image from the camera system 210 to the access control platform component 220. In some embodiments, the camera system 210 can communicate this information directly to the access control platform component 220 without utilizing the image data analysis component 222. The access control platform component 220 may send a notification regarding the detection of the unknown person to the user device 204.

When an unknown person is detected and the auto-secure operation is enabled (e.g., during a preconfigured time period), the access control system 200 can trigger the door lock system 130 to lock the interior access door 128 or another door to which the door lock system 130 is coupled or otherwise in communication when the door lock system 130 is in an unlocked state. Similarly, detection of the unknown person under these conditions can cause the access control system 200 to trigger the garage door operator 102 to automatically close the garage door 106 when the garage door 106 is open. If notifications are enabled, notifications of the garage closing and/or door locking events can be sent to the user device 204. If the door lock system 130 is locked or the garage door 106 is closed, the door lock system 130 remains locked and the garage door operator 102 keeps the garage door 106 closed upon detection of the unknown person.

In general, when the notifications are disabled, the access control platform component 220 will refrain from sending any notifications to the user device 204. Further, when the user device 204 operating the client application 228A is not instantiated/running or is not connected to the local area network 206 and/or the wide area network 208, the client application 228A will not receive any notifications until a network connection is reestablished. Similarly, when device settings of the user device 204 trigger a notification delay, the client application 228A will delay presenting any notifications on the display 266 in accordance with the device settings.

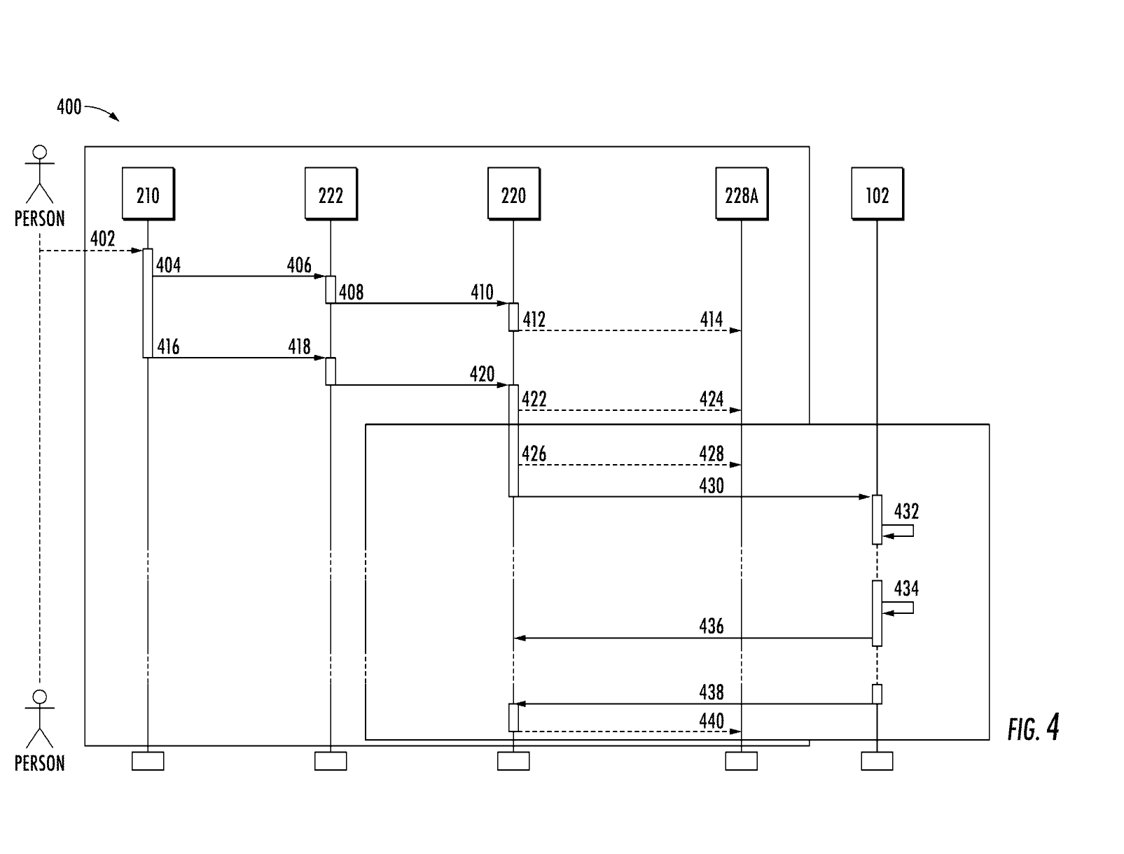

Turning now to FIGS. 4-8, example methods of operating the access control system 200 are shown. First, a method 400 is shown in FIG. 4 that includes an auto-secure operation for the garage door 106. Although FIG. 4 depicts steps performed in a particular order for purposes of illustration and discussion, the method discussed herein may not be limited to any particular order or arrangement in accordance with non-illustrated embodiments. One skilled in the art, using the disclosure provided herein, will appreciate that various steps of the method disclosed herein can be omitted, rearranged, combined, and/or adapted in various ways without deviating from the scope of the present disclosure.

The method 400 includes the camera system 210 detecting 402 a person approaching the camera system 210. The detecting 402 can be accomplished by the lens and image sensor 316 and/or the passive infrared sensor 318 as discussed previously. After the detecting 402, the method 400 includes initiating 404, e.g., capturing, a video recording of the person via the lens and image sensor 316 and sending 406 the recording, e.g., the captured recording, to the image data analysis component 222. Upon the image data analysis component 222 receiving the video data, the method 400 includes the image data analysis component 222 formulating or assembling 408 a motion detected event signal and sending 410 the motion detected event signal to the access control platform component 220. Upon receipt of the motion detected event signal by the access control platform component 220, the method 400 includes the access control platform component 220 formulating or assembling 412 a motion detected notification and sending 414 the motion detected notification to the client application 228A for presentation to a user e.g. via the display 266 of the user device 204.

Furthermore, after the detecting 402, the method 400 includes processing 416 of the initiated video recording to determine whether the unknown person is present in the video recording. In an embodiment, the processing 416 can be performed fully at the camera system 210 as seen in FIG. 4. In other embodiments, some or all of the processing 416 can be performed at the image data analysis component 222 and/or the access control platform component 220. As seen in FIG. 4, when the processing 416 is performed at the camera system 210 and indicates that an unknown person is present in the video recording, the method 400 includes sending 418 a person detection signal to the image data analysis component 222. The person detection signal can include an image of the unknown person extracted from the video recording or separately captured using the lens and image sensor 316. When the person detection signal is received by the image data analysis component 222, the method 400 includes the image data analysis component 222 sending 420 the person detection signal to the access control platform component 220. In some embodiments, the camera system 210 can bypass the image data analysis component 222 and transmit the person detection signal directly to the access control platform component 220.

When the access control platform component 220 receives the person detection signal, the method 400 includes formulating or assembling 422 a person detected notification and sending 424 the person detected notification to the client application 228A for presentation to the user via the display 266 of the user device 204. Furthermore, the method 400 includes initiating the auto-secure operation of the method 400 for the garage door 106 upon receipt of the person detection signal.

As seen in FIG. 4, the auto-secure operation of the method 400 includes the access control platform component 220 formulating or assembling 426 an auto-secure event notification and sending 428 the auto-secure event notification to the client application 228A for presentation to the user via the display 266 of the user device 204. Furthermore, the auto-secure operation of the method 400 includes the access control platform component 220 sending 430 a close command to the garage door operator 102. Upon receiving the close command, the garage door operator 102 initiates 432 an unattended close operation, whereby the garage door operator 102 flashes a light and emits a sound for a period of time such as eight seconds, before the garage door operator 102 begins closing 434 the door 106. The method 400 includes the garage door operator 102 sending 436 a door closing state indicator to the access control platform component 220. Then, after approximately twelve seconds, the door 106 reaches the closed position and the garage door operator 102 sends 438 a door is closed state indicator to the access control platform component 220. The method 400 further includes the access control platform component 220 sending 440 a garage door closed notification to the client application 228A for presentation to the user via the display 266 of the user device 204.

Some exceptions to the auto-secure operation of the method 400 can occur that will result in the garage door 106 remaining open. These exceptions include situations where the garage door operator 102 is not electrically connected to the access control platform component 220 such that the close command cannot be sent to the garage door operator 102 and situations where entrapment protection for the garage door 106 is triggered (e.g. the photo eye system 120 indicates an object is in the path of the garage door 106) so as to cause the closing garage door 106 to reverse back to the open position.

Turning now to FIG. 5, a method 500 for the door lock system 130 is shown. The method 500 includes steps 402-424 of the method 400. However, following the sending 424 of the notification to the client application 228A, the method 500 includes a different auto-secure operation beginning with sending 502 a lock command to the communication hub 132 or directly to the controllable lockset 134 in embodiments where the communication hub 132 is omitted. When the communication hub 132 receives the lock command, the method 500 includes the communication hub 132 sending 504 the lock command to the controllable lockset 134 via a Bluetooth communication. Upon receiving the lock command, the method 500 includes the controllable lockset 134 locking 505 the interior access door 128 or other door to which the door lock system 130 is associated and sending 506 a door locked state indicator to the communication hub 132 via a Bluetooth communication. When the communication hub 132 receives the door locked state indicator, the method 500 includes the communication hub 132 sending 508 the door locked state indicator to the access control platform component 220. In response to the access control platform component 220 receiving the door locked state indicator, the access control platform component 220 sends 510 a door locked notification to the client application 228A for communication to the user via the display 266 of the user device 204.

Some exceptions to the auto-secure operation of the method 500 can occur that will result in the integrated smart door lock system 130 remaining unlocked. These exceptions include situations where the communication hub 132 is not connected to the access control platform component 220 or the communication hub 132 is not connected to the controllable lockset 134 such that the close command cannot be received by the controllable lockset 134. Additional exceptions include situations where the controllable lockset 134 is misaligned with the associated strike plate, such as if the door 128 is open.

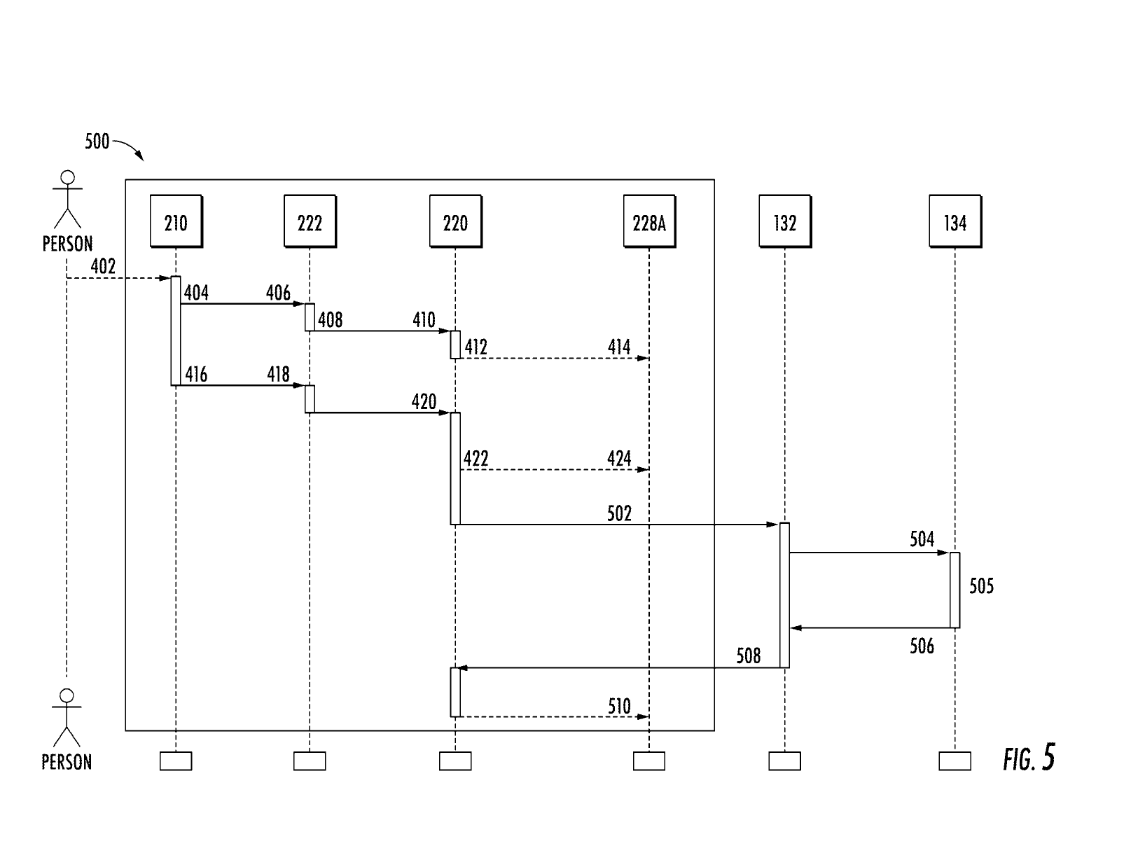

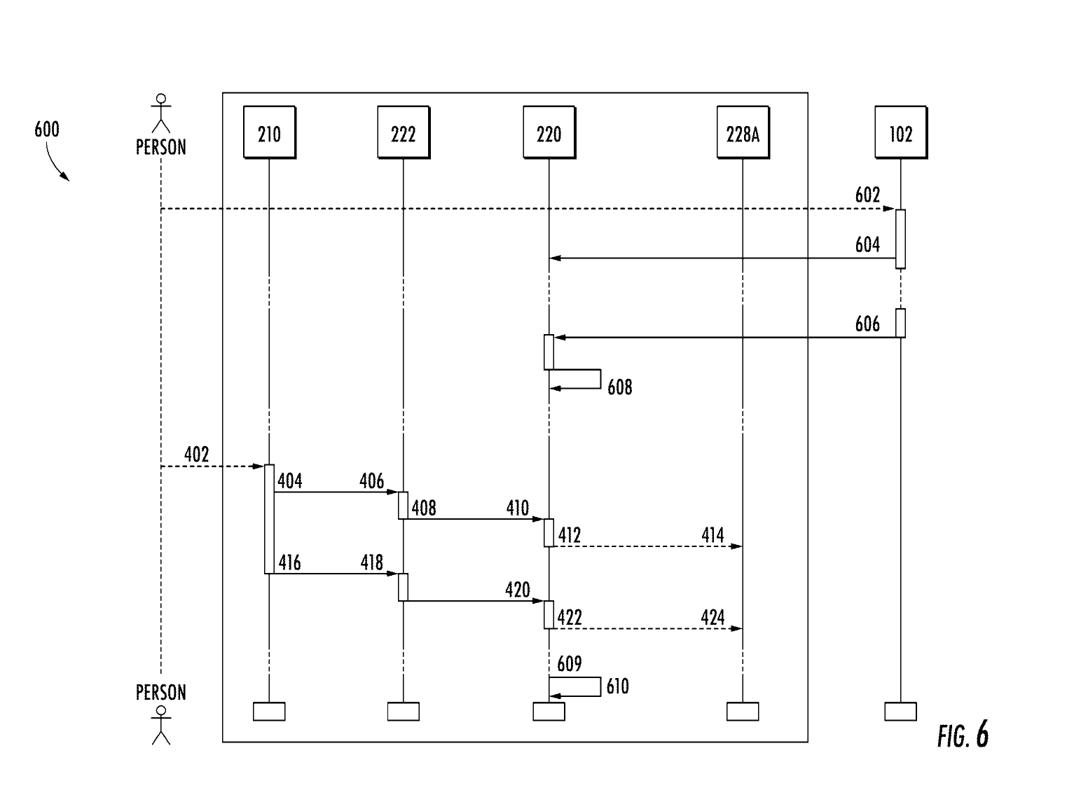

Turning now to FIG. 6, a method 600 for the garage door 106 is shown that includes an auto-secure time-out operation. The method 600 includes the steps 402-424 of the method 400 as described above, except that at when the person detection signal is received by the access control platform component 220, the auto secure feature has been temporarily disabled as a result of a controlled opening of the garage door 106.

More specifically, the method 600 can include, prior to the step of detecting motion 402, the garage door operator 102 receiving 602 a garage open command. The garage open command can be initiated in a variety of ways such as a radio frequency remote control, an in-vehicle transmitter, a wall control of the garage door operator 102, the client application 228A running on the user device 204, a third-party application in communication with the access control platform, etc. Once the open command is received, the method 600 includes the garage door operator 102 beginning to open the garage door 106 and the garage door operator 102 sending 604 a door opening state indicator to the access control platform component 220. Then, after approximately 12 seconds, the garage door 106 has reached the open position and the garage door operator 102 sends 606 a door open state indicator to the access control platform component 220. Upon the access control platform component 220 receiving the door open state indicator, the access control platform component 220 disables 608 the auto secure-operation for a predetermined time period. In some embodiments, the predetermined time period is measured by an auto-secure disable timer. Further, in some embodiments, the access control platform component 220 can disable the auto-secure operation upon receiving the door opening state indicator. Then, while the auto-secure disable timer is active and the auto-secure operation is disabled, the method 600 can include the steps 402-424. Following the sending 424, the method 600 can include the access control platform component 220 identifying 609 that the auto-secure disable timer has expired and, responsive thereto, re-enabling 610 the auto secure-feature.

Turning now to FIG. 7, a method 700 for disabling the auto secure operation is provided that is different than the approach of method 600 discussed above. In particular, the method 700 can be utilized where the garage door operator 102 is not directly connected to the access control platform component 220 over the local area network 206 and/or wide area network 208 and instead utilizes a communication hub 702 and a door position sensor 704 to detect the position and/or direction of movement of the garage door 106. For example, the communication hub 702 may be configured to communicate with the access control platform component 220 via the local area network and/or wide area network 208. The communication hub 702 transmits wired or wireless command signals to the garage door operator 102, such as radio frequency signals in the 300 MHz-400 MHz range. The communication hub 702 receives data from the door position sensor 704 via a radio frequency signal. The door position sensor 704 may include, for example, an accelerometer, a gyroscope, and/or a tilt switch.

As seen in FIG. 7, the method 700 includes the garage door operator 102 receiving 706 a garage open command. As in the method 600, the garage open command can be initiated in a variety of ways such as a radio frequency remote control, an in-vehicle transmitter, a wall control of the garage door operator 102, the client application 228A running on the user device 204, a third-party application, etc. Once the garage open command is received, the method 700 includes the garage door operator 102 opening the garage door 106 and door sensor 704 monitoring the position, orientation, and/or direction of movement of the garage door 106. When the door sensor 704 senses that the garage door 106 is open, the auto-secure time-out method 700 includes the door sensor 704 sending 708 a door is open state indicator to the access control platform component 220. Upon receiving the door is open state indicator, the method 700 includes the access control platform component 220 disabling 712 the auto-secure operation for a predetermined time period. The method 700 then continues as in the method 600 by re-enabling the auto secure operation after the auto-secure disable timer has expired.

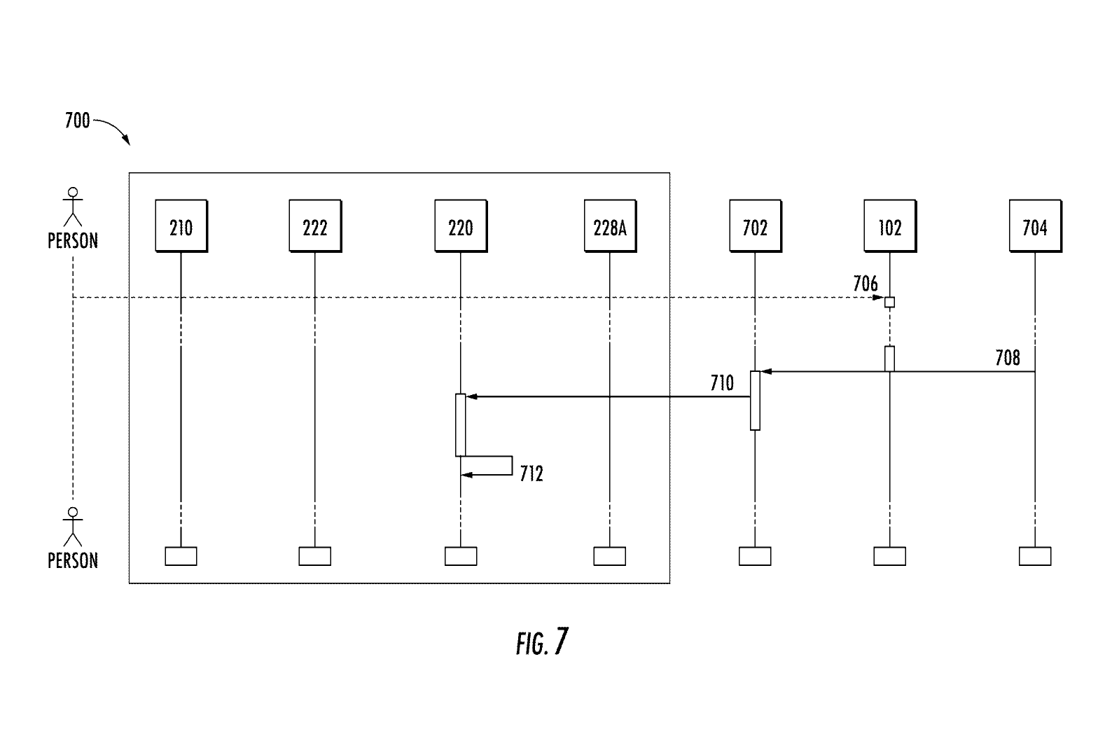

Turning now to FIG. 8, a method 800 for the interior access door 128 or other door(s) that include the door lock system 130 is shown. The auto-secure time-out method 800 includes the steps 402-424 of method 400 described above, except that when the person detection signal is received by the access control platform component 220, the auto secure feature has been temporarily disabled as a result of a controlled unlocking of the interior access door 128 or other door(s) that includes the door lock system 130.

In particular, the method 800 can include, prior to the detecting of motion 402, the controllable lockset 134 receiving 802 a door unlock command. The door unlock command can be initiated in a variety of ways such as a radio frequency remote control, an in-vehicle transmitter, a code entered on a keypad of the controllable lockset 134, the client application 228A, etc. Additionally, in embodiments where the controllable lockset 134 can be manually operated (e.g. by user input turning a knob or deadbolt), the manual operation of the controllable lockset 134 can be equivalent to receiving the door unlock command for purposes of the method 800. Once the controllable lockset 134 receives 802 the door unlock command or the controllable lockset 134 is manually opened or unlocked, the method 800 includes the controllable lockset 134 sending 804 a door unlocked state indicator to the communication hub 132. Additionally, where the controllable lockset 134 is not manually opened or unlocked, the auto-secure time-out method 800 can include automatically opening or unlocking the controllable lockset 134 in response to the door unlock command. Then, the method 800 includes the communication hub 132 sending 806 the door unlocked state indicator to the access control platform component 220. Upon the access control platform component 220 receiving the door unlocked state indicator, the access control platform component 220 sends a door unlocked notification to the client application 228A and disables 810 the auto-secure operation for a predetermined time period which may be set by a user. As with the method 600, in some embodiments, the predetermined time period is measured by the auto-secure disable timer. Then, while the auto-secure disable timer is active and the auto-secure operation is disabled, the method 800 can include the steps 402-424. Following the sending 424, the method 800 can include the access control platform component 220 identifying 812 that the auto-secure disable timer has expired and, responsive thereto, re-enabling 814 the auto-secure operation.

Turning now to FIG. 17, an example method 1700 of operating the access control system is shown to initiate an auto-secure operation. Although FIG. 17 depicts steps performed in a particular order for purposes of illustration and discussion, the method discussed herein may not be limited to any particular order or arrangement in accordance with non-illustrated embodiments. One skilled in the art, using the disclosure provided herein, will appreciate that various steps of the method disclosed herein can be omitted, rearranged, combined, and/or adapted in various ways without deviating from the scope of the present disclosure.

The method 1700 includes capturing image data associated with a region of interest associated with a camera system 1702. The region of interest may include, for example, a field of view captured by the camera system. The region of interest can include one or more sections that are selectively securable by a movable barrier and one or more sections that are unsecurable by the movable barrier (i.e., outside of the secured area). In certain instances, the region of interest includes a first section disposed between the movable barrier and the movable barrier operator (e.g., a garage interior), and a second section disposed outside the movable barrier (e.g., a driveway leading up to the garage). The camera’s field of view is bounded by edges, e.g., on four sides (a top side, a bottom side, a left side, and a right side). The edges of the field of view can be split into two or more groups including, for example, one or more edges that border the first section of the region of interest and one or more edges that border the second section of the region of interest. For example, where the camera is part of a movable barrier operator (e.g., integral with the movable barrier operator), a lower portion of the field of view may define the first section and an upper portion of the field of view may define the second section. In some implementations, the upper portion of the field of view can correspond to an interior of the secured area, such as an upper area associated with the garage where garage rails extend to support the garage door in the open position. In such instances, the unsecurable area may be defined by a middle portion of the field of view between the upper and lower portions. Similarly, in some implementations, the left and right sides of the field of view may correspond to the interior of the field of view. In such instances, the unsecurable area may be defined by a middle portion of the field of view setback from the left and right sides. For example, with reference to FIGS. 15 and 16, the edges of the field of view all correspond with the interior of a garage. In this instance, the second section is fully surrounded by the first section. The second section can be automatically delineated, for example as described above, e.g., using a processor, or manually set by the user. In some instances, the edge(s) of the field of view can include two edges including an outside edge that forms a boundary of the first section and an interior edge that forms a boundary of the second section. The system described herein can use the edge through which an object appears when entering the camera’s field of view to determine whether the object is moving from the secured area or towards the secured area. Where the object initially enters the field of view by passing over one or more edges associated with the first section, the object may be deemed as trustworthy since the edges associated with the first section correspond to the secured area. Conversely, where the object initially enters the field of view by passing over one or more edges associated with the second section, the object may be deemed as unknown since the edges associated with the second section correspond to the unsecurable area, e.g., outside environment.

The method 1700 further includes detecting an object entering the region of interest 1704. Detecting the object may be performed by the camera system. In an embodiment, the camera system can exit a sleep mode upon detecting motion and capture image data in response thereto. The object may be detected in the first section of the field of view, the second section of the field of view, or both. Where the object is detected in the first section of the field of view, the object is presumed to already be within the secured area. By way of example, this can include a person leaving a house and entering a garage in which the camera system is installed. Where the object is detected in the second section of the field of view, the object is presumed to be outside the secured area, such as for example, along a walkway or driveway outside of the secured area. Upon detecting the object, the camera system may utilize a motion tracking algorithm to track the object within the field of view. The camera system may include time of flight (ToF) or another type of distance determination module to determine a distance to the object. In certain instances, the camera system, or another portion of the system described herein, can actively track the distance to the object to ascertain whether the object is moving nearer or further away from the camera system. The distance information can be used as part of the method 1700 to inform an auto-secure operation as described below.

The method 1700 further includes analyzing the image data to determine whether the object is a trusted entity 1706. Trusted entities are generally afforded access to the secured area while other entities, such as unknown entities and distrusted entities, are not afforded access to the secured area. In an embodiment, determining whether the object is a trusted entity includes comparing the edge of the region of interest from which the object enters the region of interest to reference data to determine whether the edge corresponds to the secured area. The reference data can include the predetermined edges as described above. For example, where the object is detected crossing from the second section of the region of interest into the first section of the region of interest, the detected object is getting nearer to the secured area. Meanwhile, where the object is detected crossing the edge from the first section of the region of interest into the second section of the region of interest, the detected object is moving away from the secured area. By way of example, where the detected object enters into the region of interest from an outside lower edge of the camera’s field of view, the object is determined to be a trusted entity since the outside lower edge of the camera’s field of view corresponds with the secured area. See for example FIGS. 15 and 16 which illustrate the outside lower edge of the camera’s field of view as corresponding to an interior of a garage. Yet other means of determining whether the object is a trusted entity 1706 may be employed in addition to or in substitute for the example provided above. For example, the determination may be made in view of a carried user device that is detectable by the camera system or another sensor system (such as an access point which tracks the position of the user device, e.g., using triangulation or another technique). Yet further, the determination may be made in view of a user interaction within the secured environment. For instance, where a keypad (such as a security system keypad) or other user-activatable device is located near a house door into the garage, feedback received at the keypad can indicate the person subsequently entering the field of view came from inside the house through the house door. Similarly, where an internal camera located near the house door detects a person leaving the house and entering the garage, the system can understand that the subsequently detected person in the field of view of the camera system is a trusted entity. Similarly, where the house door is connected to the system, e.g., by an electromechanical lock in communication with the system, opening of the house door can trigger a notification such that subsequent detection of a person entering the field of view can be determined as a trusted entity. Yet other methods of authenticating the trust status of a person or object entering the field of view may be utilized.

The method 1700 further includes, in response to determining the object is a trusted entity, analyzing the image data to determine a re-identification characteristic associated with the trusted entity. The re-identification characteristic can include any characteristic of the entity as described herein. For example, the re-identification characteristic can include a measured dimension, an approximate weight, a color or shape, a gait pattern, a biometric attribute, indicia (e.g., lettering on a jacket or hat), or the like. In some instances, the re-identification characteristic is a single data point (e.g., a color value of a detected item carried or worn by the trusted entity). In other instances, the re-identification characteristic includes multiple data points (e.g., a color value, an estimated dimension, a hairstyle, etc.). The number of data points collected for the re-identification characteristic can be determined in view of a logic threshold (i.e., how likely are already-collected data point(s) to be sufficiently unique for re-identification), a user set value (e.g., how sensitive the user wants the system to operate), a number of detectable characteristics, and the like. In some instances, the re-identification characteristic is only capturable within a preset period of time. For example, the preset period of time can be five (5) seconds, ten (10) seconds, twenty (20) seconds, etc. If the trusted entity remains in the region of interest longer than the preset period of time, the re-identification characteristic determination may not be further adjusted or modified.

Once the re-identification characteristics are determined 1708, the method 1700 includes storing the re-identification characteristics 1710. The re-identification characteristics can be stored, for example, in a ledger saved to memory. The re-identification characteristics can be assigned to a profile as a trusted entity. The re-identification characteristic can be stored for a re-identification period corresponding with a set duration of time. After expiration of the re-identification period, the re-identification characteristic (and optionally the profile altogether) may be removed, e.g., deleted, from the ledger. In this regard, the system is less likely to store characteristics that are no longer useful for re-identification purposes. For example, where the re-identification characteristic includes a color of an article of clothing worn by the trusted entity, it is unlikely that the re-identification characteristic will be useful even 24 hours later as the entity is likely to change clothes within a 24-hour period. To eliminate the potential for erroneous re-identification of a non-trusted entity using the aged re-identification characteristic, the system can remove such re-identification characteristics upon expiration of the re-identification period. In some implementations, the duration of the re-identification period can correspond to a preset duration of time which begins counting down in response to storing the re-identification characteristic in the ledger. For example, the re-identification period can be thirty (30) minutes, one (1) hour, five (5) hours, twelve (12) hours, or twenty four (24) hours. In other instances, the re-identification period can correspond to daily periods (i.e., 12:00 AM to 11:59 PM) and reset daily. In yet other instances, the re-identification period can change based on the type of attribute stored as the re-identification characteristic. For example, where the re-identification characteristic corresponds to an estimated height or gait, the re-identification period may extend for a greater period of time than where the re-identification characteristic is a clothing color. Relative re-identification period durations can be preset, stored in memory, and accessible for periodic removal of the re-identification characteristics from the ledger. Moreover, the user may be able to modify the re-identification period durations, e.g., using a smart device.

The method 1700 further includes detecting a new object entering the region of interest after the trusted entity exited the region of interest 1712. The new object may enter the region of interest simply by entering the camera’s field of view. Prior to the trusted entity exiting the region of interest it may be possible to determine presence of the trusted entity through motion tracking. That is, until the trusted entity leaves the field of view, it is easy to identify the trusted entity and control auto-secure of the movable barrier based on motion tracking. However, at some point the trusted entity may exit the field of view. At some later time, the camera system detects the new object entering the field of view. The new object may correspond to the trusted entity or a different entity or object. Thus, the method 1700 can include analyzing the image data to determine presence of the re-identification characteristic for the new object 1714. For example, the image data can be processed to determine one or more characteristics of the new object. The determined characteristic(s) can be compared to the re-identification characteristics stored at the ledger.

The method 17000 can include initiating an auto-secure operation in response to determining a lack of presence of the re-identification characteristic for the new object 1716. In some instances, the system can initiate the auto-secure operation prior to fully completing all of the above steps in order to secure the movable barrier prior to the unknown object reaching the movable barrier. That is, closing the movable barrier may take a relatively long period of time (e.g., ten seconds). By initiating close prior to completing the above steps, the movable barrier may be partially closed in advance of step 1714. Where the new object is not the trusted entity, this advanced state of closure increases security and reduces the chance that the object reaches the secured area prior to closure. Where the new object is later determined to be the trusted entity, the movable barrier operator can be reversed to fully re-open the movable barrier. In an embodiment, early closure of the movable barrier may be selectively initiated in response to a trigger. By way of example, the trigger can include distance-to-object data indicating the object is rapidly approaching the movable barrier, such as when a detected person runs towards the secured area. By prematurely initiating closure, the system is less likely to permit entrance of an unknown or known and distrusted entity into the secured area. By way of another example, the trigger can include certain preset characteristics determined at step 1714. For example, where step 1714 detects a weapon (such as a gun or knife), the method 1700 can skip any comparison or analysis step and immediately move to initiating the auto-secure operation 1716, reducing the time required to close the movable barrier.

The method 1700 can utilize re-identification for purposes of preventing a trusted entity from becoming locked out of their home or another secured area. In some instances, the method 1700 can further include initiating an auto-open operation in response to determining that the detected object is the trusted entity even after initiating the auto-secure operation. The trusted entity may alternatively be permitted entry after the auto-secure operation is completed by entering a passcode at a keypad, by performing a secrete authorization credential in the field of view of the camera, or the like.

Turning now to FIGS. 9-12, views of a graphical user interface displayed on the display 266 of the user device 204 are shown. First, FIG. 9 shows a composite live or recorded view of the visual input 238 for multiple camera systems 210. The composite live view includes views from multiple camera systems 210 that captured the unknown person entering the region of interest of one or more of the camera systems 210. In some embodiments, the composite live view is triggered by a first camera system that detects a person or similar security event and then activating one or more secondary camera systems that are linked to the first camera system to begin recording as a result of the same person detection or security event so as to get additional vantage points.

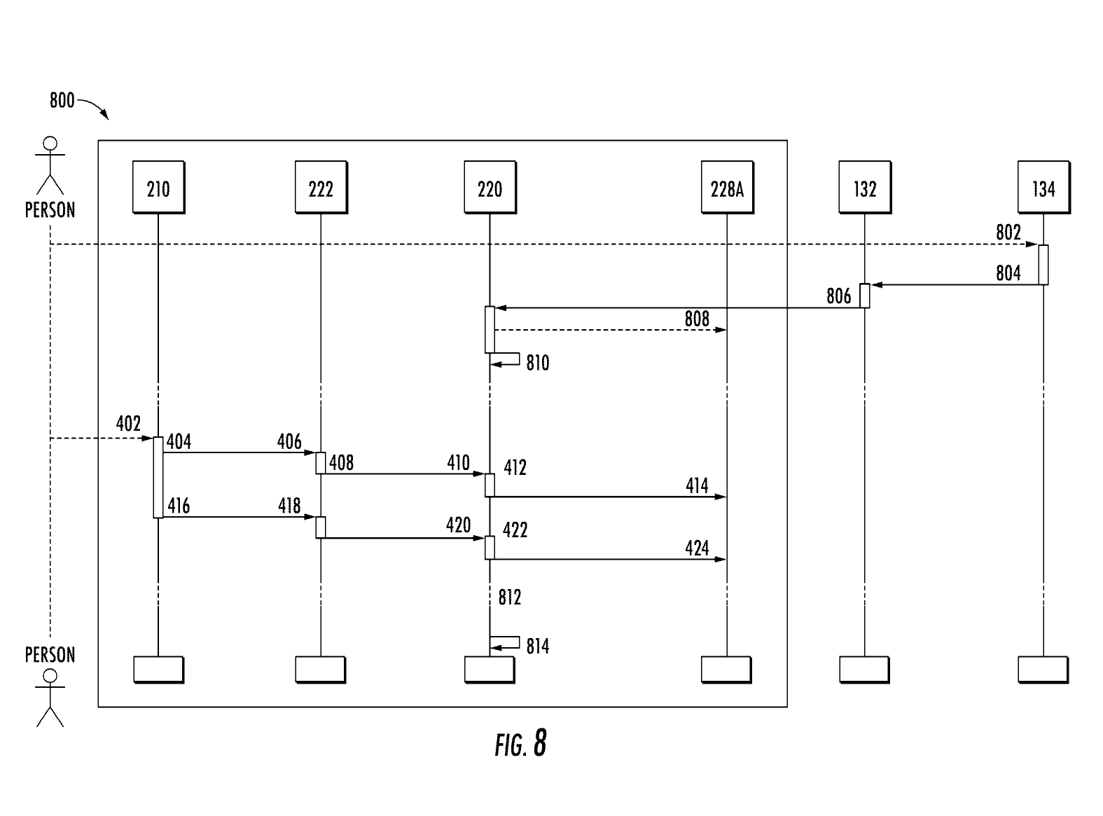

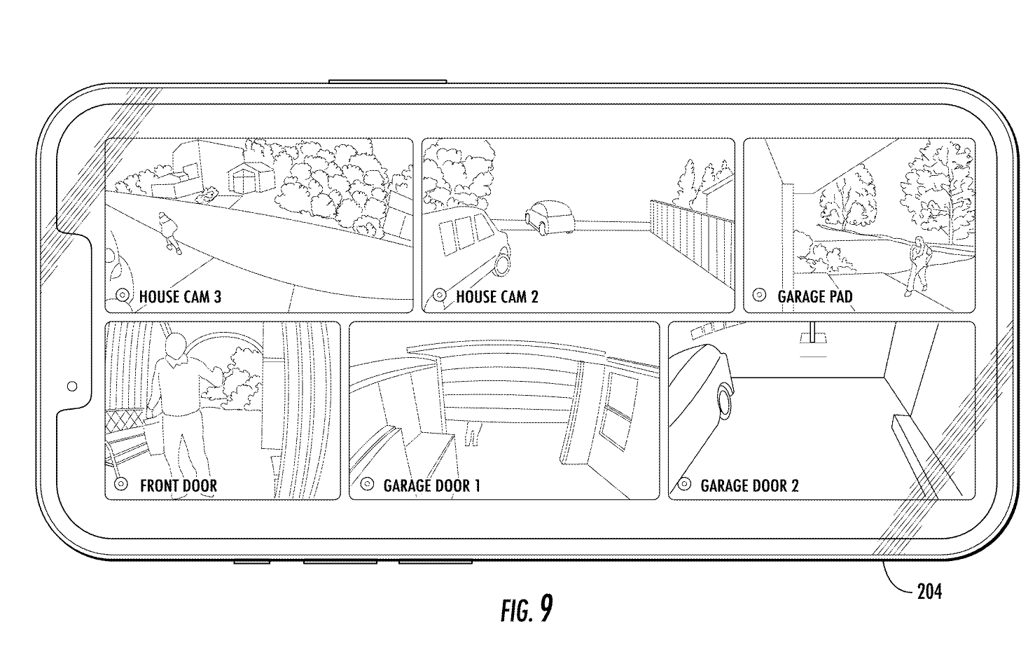

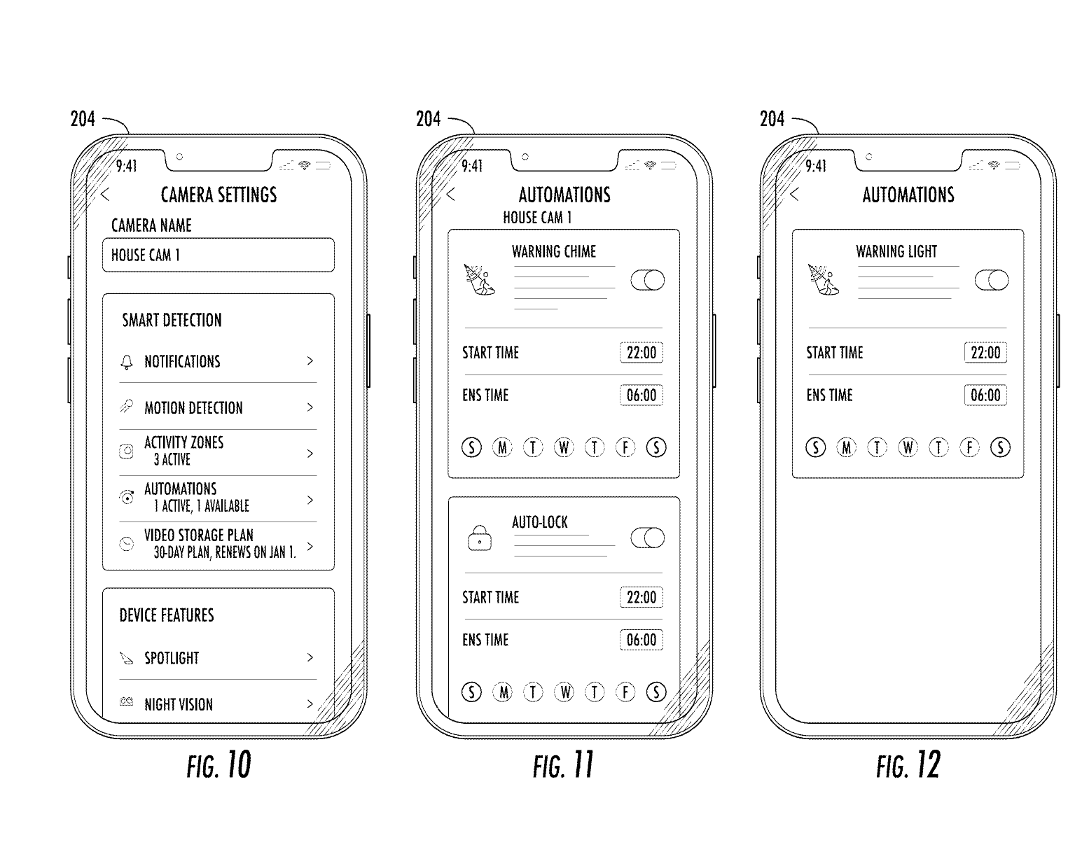

Second, FIG. 10 shows a settings page of the graphical user interface e.g. of the client application 228A and FIGS. 11 and 12 show an automation sub-menu of the camera settings e.g. of the client application 228A. As seen in FIGS. 11 and 12, the automation sub-menu can include options for time activating a chime output of the camera system 210, configurations options for the auto-lock operation (e.g. the auto-secure operation described in detail previously), and options for time activating warning lights (e.g. the spotlight 326 and/or the flood light 306).

Further aspects of the invention are provided by one or more of the following embodiments:

Embodiment 1. A method of initiating an auto-secure operation associated with a movable barrier operator, the method comprising: capturing, via a camera system, image data associated with a region of interest associated with the camera system; detecting, via the camera system, an object entering the region of interest; analyzing, via a processor in communication with the camera system, the image data to determine whether the object is a trusted entity; in response to determining the object is a trusted entity, analyzing the image data to determine a re-identification characteristic associated with the trusted entity; storing the re-identification characteristic in a ledger; detecting, via the camera system, a new object entering the region of interest after the trusted entity exited the region of interest; analyzing, via the processor, the image data to determine presence of the re-identification characteristic for the new object; and initiating an auto-secure operation including sending a close command to a movable barrier operator to cause the movable barrier operator to close a movable barrier associated with the movable barrier operator in response to determining a lack of presence of the re-identification characteristic for the new object.

Embodiment 2. The method of embodiment 1, wherein determining whether the object is a trusted entity comprises: determining an edge of the region of interest from which the object enters the region of interest; comparing the edge of the region of interest to reference data to determine whether the edge corresponds to a secured area; and associating a trust status to the entity based on the comparing.

Embodiment 3. The method of embodiment 2, wherein the camera system is disposed at the movable barrier operator, wherein the region of interest includes a first section disposed between the movable barrier and the movable barrier operator and a second section disposed outside the movable barrier, and wherein the edge of the region of interest associated with the trusted entity corresponds to one or more edges associated with the first section.

Embodiment 4. The method of embodiment 2, wherein the camera system is disposed at the movable barrier operator, wherein the region of interest includes a first section disposed between the movable barrier and the movable barrier operator and a second section disposed outside the movable barrier, and wherein the edge of the region of interest associated with detecting the new object entering the region of interest corresponds to one or more edges associated with the second section.

Embodiment 5. The method of any one or more of embodiments 1 to 4, wherein the re-identification characteristic comprises a height of the trusted entity, an estimated weight or lateral dimension of the trusted entity, a detected clothing style, a detected clothing color, inclusion of an accessory coupled to the trusted entity, a gait associated with the trusted entity, a biometric attribute or indicia, or any combination thereof.

Embodiment 6. The method of any one or more of embodiments 1 to 5, further comprising initiating, by the processor, a time-out operation in response to the trusted entity exiting the region of interest, and initiating the auto-secure operation in response to expiration of the time-out operation.

Embodiment 7. The method of any one or more of embodiments 1 to 6, wherein re-identification characteristic is stored in the ledger during a re-identification period, and wherein the re-identification period expires after a preset duration of time after which the re-identification characteristic is removed from the ledger.

Embodiment 8. The method of embodiment 7, wherein the preset duration of time begins in response to storing the re-identification characteristic in the ledger.

Embodiment 9. The method of any one or more of embodiments 1 to 8, further comprising comparing a detected characteristic of the new object to a list of known, distrusted entities and notifying at least one of an account holder or law enforcement in response to the comparing.

Embodiment 10. The method of any one or more of embodiments 1 to 9, wherein the region of interest comprises a first region of interest and a second region of interest, wherein the camera system comprises a plurality of cameras including a first camera that detects the object entering the first region of interest and a second camera that detects a new object entering the second region of interest, wherein the first region of interest corresponds with an area secured by the movable barrier operator, and wherein at least a portion of the second region of interest includes an exterior area unsecurable by the movable barrier operator.

Embodiment 11. A non-transitory computer-readable medium storing instructions which, when executed by a processor, cause performance of a method of initiating an auto-secure operation of a movable barrier operator, the method comprising: receiving, at an access control system, a person detection signal indicative of a person within a region of interest near a movable barrier operator, wherein the person detection signal is determined in view of image data captured by a camera system; analyzing, by the access control system, the image data to determine a characteristic of the person, a biometric attribute of the person, indicia associated with the person, or a combination thereof; comparing, by the access control system, the characteristic to a re-identification characteristic associated with a known, entrusted entity; initiating, by the access control system, an auto-secure operation based on the comparing, wherein initiating the auto-secure operation comprises: formulating, by the access control system, an unknown person detected notification; transmitting the unknown person detected notification to a user device; and sending a close command to the movable barrier operator to cause the movable barrier operator to close a movable barrier associated with the movable barrier operator.

Embodiment 12. The non-transitory computer-readable medium of embodiment 11, wherein initiating the auto-secure operation further comprises transmitting a lock command to a controllable lockset associated with an interior access door to cause the controllable lockset to lock the interior access door.

Embodiment 13. The non-transitory computer-readable medium of any one or more of embodiments 11 or 12, further comprising: analyzing the image data to determine an edge of the region of interest from which the person entered the region of interest; comparing the edge of the region of interest to reference data to determine whether the edge corresponds to a secured area; and associating a trust status to the entity based on the comparing prior to initiating the auto-secure operation.

Embodiment 14. The non-transitory computer-readable medium of embodiment 13, wherein the camera system is disposed at the movable barrier operator, wherein the region of interest includes a first section disposed between the movable barrier and the movable barrier operator and a second section disposed outside the movable barrier, wherein the edge of the region of interest associated with person entering the region of interest corresponds to one or more edges associated with the second section, and wherein the person is associated with an unknown or distrusted trust status.

Embodiment 15. The non-transitory computer-readable medium of any one or more of embodiments 11 to 14, wherein the region of interest comprises a plurality of regions of interest each arranged to cover a different location within an area associated with the camera system.

Embodiment 16. A camera subsystem for use with a movable barrier operator, the camera subsystem comprising: a camera system that receives a camera system input selected from a group including an environment input, a power input, an ambient lighting input, a visual input, an audio input, and a motion input; and a server subsystem, wherein the server subsystem comprises a processor coupled to a memory, the processor configured to: process image data received from the camera system to determine whether a person is present in the image data; analyze the image data to determine whether the person is a trusted entity; in response to determining the person is a trusted entity, analyze the image data to determine a re-identification characteristic associated with the trusted entity; cause the re-identification characteristic to be stored in a ledger; detect a new person present in the image data; analyze the image data to determine presence of the re-identification characteristic for the new person; and initiate an auto-secure operation including sending a close command to a movable barrier operator to cause the movable barrier operator to close a movable barrier associated with the movable barrier operator in response to determining a lack of presence of the re-identification characteristic for the new person.

Embodiment 17. The camera subsystem of embodiment 16, wherein the camera system is configured to generate an output selected from a group including a night vision output, a visible light output, a sound output, and a status indicator.

Embodiment 18. The camera subsystem of any one or more of embodiments 16 or 17, wherein the camera system captures image data associated with a region of interest associated with the camera system, and wherein the region of interest comprises a plurality of regions of interest each arranged to cover a different location within a secured area associated with the camera system.

Embodiment 19. The camera subsystem of any one or more of embodiments 16 to 18, wherein capturing the image data is performed in response to detecting, by a motion input, motion in the region of interest.

Embodiment 20. The camera subsystem of any one or more of embodiments 16 to 19, wherein the server subsystem is further configured to transmit a lock command to a controllable lockset associated with an interior access door to cause the controllable lockset to lock the interior access door in response to receiving the person detection signal.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A method of initiating an auto-secure operation associated with a movable barrier operator, the method comprising:
capturing, via a camera system, image data associated with a region of interest associated with the camera system;
detecting, via the camera system, an object entering the region of interest;
analyzing, via a processor in communication with the camera system, the image data to determine whether the object is a trusted entity;
in response to determining the object is a trusted entity, analyzing the image data to determine a re-identification characteristic associated with the trusted entity;
storing the re-identification characteristic in a ledger;
detecting, via the camera system, a new object entering the region of interest after the trusted entity exited the region of interest;
analyzing, via the processor, the image data to determine presence of the re-identification characteristic for the new object; and
initiating an auto-secure operation including sending a close command to a movable barrier operator to cause the movable barrier operator to close a movable barrier associated with the movable barrier operator in response to determining a lack of presence of the re-identification characteristic for the new object.

2. The method of claim 1, wherein determining whether the object is a trusted entity comprises:
determining an edge of the region of interest from which the object enters the region of interest;
comparing the edge of the region of interest to reference data to determine whether the edge corresponds to a secured area; and
associating a trust status to the entity based on the comparing.

3. The method of claim 2, wherein the camera system is disposed at the movable barrier operator, wherein the region of interest includes a first section disposed between the movable barrier and the movable barrier operator and a second section disposed outside the movable barrier, and wherein the edge of the region of interest associated with the trusted entity corresponds to one or more edges associated with the first section.

4. The method of claim 2, wherein the camera system is disposed at the movable barrier operator, wherein the region of interest includes a first section disposed between the movable barrier and the movable barrier operator and a second section disposed outside the movable barrier, and wherein the edge of the region of interest associated with detecting the new object entering the region of interest corresponds to one or more edges associated with the second section.

5. The method of claim 1, wherein the re-identification characteristic comprises a height of the trusted entity, an estimated weight or lateral dimension of the trusted entity, a detected clothing style, a detected clothing color, inclusion of an accessory coupled to the trusted entity, a gait associated with the trusted entity, a biometric attribute or indicia, or any combination thereof.

6. The method of claim 1, further comprising initiating, by the processor, a time-out operation in response to the trusted entity exiting the region of interest, and initiating the auto-secure operation in response to expiration of the time-out operation.

7. The method of claim 1, wherein re-identification characteristic is stored in the ledger during a re-identification period, and wherein the re-identification period expires after a preset duration of time after which the re-identification characteristic is removed from the ledger.

8. The method of claim 7, wherein the preset duration of time begins in response to storing the re-identification characteristic in the ledger.

9. The method of claim 1, further comprising comparing a detected characteristic of the new object to a list of known, distrusted entities and notifying at least one of an account holder or law enforcement in response to the comparing.

10. The method of claim 1, wherein the region of interest comprises a first region of interest and a second region of interest, wherein the camera system comprises a plurality of cameras including a first camera that detects the object entering the first region of interest and a second camera that detects a new object entering the second region of interest, wherein the first region of interest corresponds with an area secured by the movable barrier operator, and wherein at least a portion of the second region of interest includes an exterior area unsecurable by the movable barrier operator.

11. A non-transitory computer-readable medium storing instructions which, when executed by a processor, cause performance of a method of initiating an auto-secure operation of a movable barrier operator, the method comprising:
receiving, at an access control system, a person detection signal indicative of a person within a region of interest near a movable barrier operator, wherein the person detection signal is determined in view of image data captured by a camera system;
analyzing, by the access control system, the image data to determine a characteristic of the person, a biometric attribute of the person, indicia associated with the person, or a combination thereof;
comparing, by the access control system, the characteristic to a re-identification characteristic associated with a known, entrusted entity;
initiating, by the access control system, an auto-secure operation based on the comparing, wherein initiating the auto-secure operation comprises:
formulating, by the access control system, an unknown person detected notification;
transmitting the unknown person detected notification to a user device; and
sending a close command to the movable barrier operator to cause the movable barrier operator to close a movable barrier associated with the movable barrier operator.

12. The non-transitory computer-readable medium of claim 11, wherein initiating the auto-secure operation further comprises transmitting a lock command to a controllable lockset associated with an interior access door to cause the controllable lockset to lock the interior access door.

13. The non-transitory computer-readable medium of claim 11, further comprising:
analyzing the image data to determine an edge of the region of interest from which the person entered the region of interest;
comparing the edge of the region of interest to reference data to determine whether the edge corresponds to a secured area; and
associating a trust status to the entity based on the comparing prior to initiating the auto-secure operation.

14. The non-transitory computer-readable medium of claim 13, wherein the camera system is disposed at the movable barrier operator, wherein the region of interest includes a first section disposed between the movable barrier and the movable barrier operator and a second section disposed outside the movable barrier, wherein the edge of the region of interest associated with person entering the region of interest corresponds to one or more edges associated with the second section, and wherein the person is associated with an unknown or distrusted trust status.

15. The non-transitory computer-readable medium of claim 11, wherein the region of interest comprises a plurality of regions of interest each arranged to cover a different location within an area associated with the camera system.

16. A camera subsystem for use with a movable barrier operator, the camera subsystem comprising:
a camera system that receives a camera system input selected from a group including an environment input, a power input, an ambient lighting input, a visual input, an audio input, and a motion input; and
a server subsystem, wherein the server subsystem comprises a processor coupled to a memory, the processor configured to:
process image data received from the camera system to determine whether a person is present in the image data;
analyze the image data to determine whether the person is a trusted entity;
in response to determining the person is a trusted entity, analyze the image data to determine a re-identification characteristic associated with the trusted entity;
cause the re-identification characteristic to be stored in a ledger;
detect a new person present in the image data;
analyze the image data to determine presence of the re-identification characteristic for the new person; and
initiate an auto-secure operation including sending a close command to a movable barrier operator to cause the movable barrier operator to close a movable barrier associated with the movable barrier operator in response to determining a lack of presence of the re-identification characteristic for the new person.

17. The camera subsystem of claim 16, wherein the camera system is configured to generate an output selected from a group including a night vision output, a visible light output, a sound output, and a status indicator.

18. The camera subsystem of claim 16, wherein the camera system captures image data associated with a region of interest associated with the camera system, and wherein the region of interest comprises a plurality of regions of interest each arranged to cover a different location within a secured area associated with the camera system.

19. The camera subsystem of claim 18, wherein capturing the image data is performed in response to detecting, by a motion input, motion in the region of interest.

20. The camera subsystem of claim 16, wherein the server subsystem is further configured to transmit a lock command to a controllable lockset associated with an interior access door to cause the controllable lockset to lock the interior access door in response to receiving the person detection signal.
